(19) United States
(12) Patent Application Publication
(10) Pub. No.: US 2025/0240176 A1
(43) Pub. Date: Jul. 24, 2025

(54) METHOD FOR VERIFYING A TRANSFER OF A MATERIAL BETWEEN A MATERIAL OWNER AND A MATERIAL RECIPIENT IN A DECENTRAL NETWORK

(71) Applicant: BASF SE, Ludwigshafen am Rhein (DE)

(72) Inventor: Henning SCHWABE, Ludwigshafen am Rhein (DE)

(21) Appl. No.: 18/881,581

(22) PCT Filed: Jun. 23, 2023
(86) PCT No.: PCT/EP2023/067180

§ 371 Date: Jan. 6, 2025

(30) Foreign Application Priority Data
Jul. 5, 2022 (EP) 22183049.0
Jul. 5, 2022 (EP) 22183050.8
Jul. 5, 2022 (EP) 22183059.9
Jul. 5, 2022 (EP) 22183064.9
Jul. 5, 2022 (EP) 22183065.6
Jul. 5, 2022 (EP) 22183074.8
Jul. 6, 2022 (EP) 22183367.6

(51) Int. Cl. H04L 9/32

(52) U.S. Cl. CPC H04L 9/3263; H04L 9/3247

(57) ABSTRACT

Disclosed is a computer-implemented method for verifying a transfer of a material between a material owner and a material recipient in a decentral network is disclosed, the network comprising a distributed ledger that includes multiple member nodes and a distributed ledger application. The method includes the step of transmitting, by a requestor, a material transaction request to the distributed ledger application, the material transaction request containing material data associated with the material, and the cryptographic credential(s) of the material owner and optionally the material recipient associated with the transfer of the material. The method further includes the step of receiving confirmation, or denial of a commitment of the material transaction request as material transaction to the distributed ledger. The distributed ledger application is configured to receive the material transaction request from the requestor, verify the transfer of the material associated with the request by validating the cryptographic credential(s) of the material owner and optionally the material recipient contained in the material transaction request. The distributed ledger application is configured to commit—if the transfer of the material is verified—the material transaction request as material transaction to the distributed ledger and transmit confirmation of commitment of the material transaction request, or transmit—if the transfer of the material is not verified—denial of commitment of the material transaction request.

### TECHNICAL FIELD

The present disclosure relates to a computer-implemented method and apparatus for verifying a transfer of a material between a material owner and a material recipient in a decentral network, a use of the verified material transfer and a computer element.

### TECHNICAL BACKGROUND

The present disclosure relates, in general terms, to tracking and documenting transfers of material, also referred to as material transfers, in a distributed system. The commonly used implementation of a distributed system is either a more centralized system, generally having a central authority having oversight, or a decentralized system.

Both types of system have challenges. While a centralized system allows for reliable tracking and documentation of material transfers, it may not be applicable for all applications. More decentralized solutions make reliable tracking and documentation more difficult to implement since there is no central authority that has oversight.

Hence, there is a need to allow for improved tracking and documenting of transfers of material in a decentral material network, particularly, for allowing system wide performance assessment and, optionally, performance adjustment.

Even more specifically, there is a need to allow for such tracking and documenting of transfers while also taking into account privacy concerns of participants to the transfer.

### SUMMARY OF THE INVENTION

In one aspect a computer-implemented method for providing a material data set associated with a transfer of a material from a material owner to a material recipient using a decentral material network is disclosed. The decentral network comprises a distributed ledger that includes multiple member nodes, the distributed ledger including material transfer transactions. At least one of the material transfer transactions is associated with the transfer of the material and comprises transaction meta data. The transaction meta data contain material production data.

The transaction meta data also contain a material identifier related to at least two different material data sets, one of the material data sets being associated with the transfer of the material. The method includes the steps of receiving the transaction meta data associated with the transfer of the material from the distributed ledger, and retrieving-based on the material identifier and the material production data contained in the transaction meta data-the material data set associated with the transfer of the material.

In another aspect an apparatus for providing a material data set associated with a transfer of a material from a material owner to a material recipient using a decentral material network comprising a distributed ledger that includes multiple member nodes is disclosed. The distributed ledger includes material transfer transactions. At least one of the material transfer transactions is associated with the transfer of the material and comprises transaction meta data containing material production data and a material identifier related to at least two different material data sets, one of the material data sets being associated with the transfer of the material. The apparatus comprises one or more computing nodes and one or more computer-readable media having stored thereon computer-executable instructions that are structured such that, when executed by the one or more computing nodes, they cause the apparatus to perform the steps according to the method of the present disclosure.

In yet another aspect, a use of the material data set provided according to the method of the present disclosure or by the apparatus of the present disclosure to determine the quality of the transferred product associated with the provided material data set or to further process the transferred material associated with the provided material data set is disclosed.

In another aspect a computer-implemented method for verifying a transfer of a material between a material owner and a material recipient in a decentral network is disclosed, the network comprising a distributed ledger that includes multiple member nodes and a distributed ledger application. The method includes the step of transmitting, by a requestor, a material transaction request to the distributed ledger application, the material transaction request containing material data associated with the material, and the cryptographic credential(s) of the material owner and optionally the material recipient associated with the transfer of the material. The method further includes the step of receiving confirmation, or denial of a commitment of the material transaction request as material transaction to the distributed ledger. The distributed ledger application is configured to receive the material transaction request from the requestor and verify the transfer of the material associated with the material transaction request by validating the cryptographic credential(s) of the material owner and optionally the material recipient contained in the material transaction request. The distributed ledger application is configured to commit—if the transfer of the material is verified—the material transaction request as material transaction to the distributed ledger and transmit confirmation of commitment of the material transaction request, or transmit—if the transfer of the material is not verified—denial of commitment of the material transaction request.

In another aspect an apparatus for verifying a transfer of a material between a material owner and a material recipient in a decentral material network comprising a distributed ledger that includes multiple member nodes and a distributed ledger application is disclosed. The apparatus comprises one or more computing nodes and one or more computer-readable media having stored thereon computer-executable instructions that are structured such that they, when executed by the one or more computing nodes, cause the apparatus, particularly one or more of the computing nodes, to perform the steps of transmitting, by a requestor, a material transaction request to the distributed ledger application, the material transaction request containing material data associated with the material, and the cryptographic credential(s) of the material owner and optionally the material recipient associated with the transfer of the material, and receiving confirmation, or denial of a commitment of the material transaction request as material transaction associated with the material transaction request to the distributed ledger. The distributed ledger application is configured to receive the material transaction request from the requestor, verify the transfer of the material associated with the material transaction request by validating the cryptographic credential(s) of the material owner and optionally the material recipient contained in the material transaction request. The distributed ledger application is configured to commit—if the transfer of the material is verified—the material transaction request as material transaction to the distributed ledger and transmit confirmation of commitment of the material transaction request, or transmit-if the transfer of the material is not verified—denial of commitment of the material transaction request.

In another aspect a computer-implemented method for verifying a transfer of a material from a material owner to a material recipient in a decentral material network comprising a distributed ledger that includes multiple member nodes is provided. The distributed ledger includes material transfer transactions containing material data associated with the material and randomized cryptographic credential(s) of the material owner and/or randomized cryptographic credential(s) of the material recipient associated with the transfer of the material. The method includes receiving the randomized cryptographic credential(s) of the material owner and/or the randomized cryptographic credential(s) of the material recipient and the identity of the material transfer transaction associated with the transfer of the material. The method also includes the step of verifying the transfer of the material by verifying the randomized cryptographic credential(s) of the material owner and/or the randomized cryptographic credential(s) of the material recipient in the material transfer transaction based on the received randomized cryptographic credential(s) and the received identity of the material transfer transaction. As an example, the randomized cryptographic credential(s) may comprise a public key generated and used to sign only one transaction submitted to the distributed ledger, as explained in detail below.

Even more specifically, as an example, it may be possible to perform verifiable incognito attestation of material transfer transactions. Generally, transactions on a distributed ledger are transparent to all participants. If user IDs associated with transactions were transparent, this would mean that transactions could be analyzed, e.g., for time patterns or the like, such that participants could derive sensitive information from the transactions in spite of data associated with the material transfer as such being kept private. The present invention allows for keeping user IDs associated with a transaction anonymous while also keeping the transaction verifiable in all its aspects.

Specifically, by using the randomized cryptographic credentials, particularly by using cryptographic credentials unique to a transaction, it is possible to verify a transaction while also protecting the identity of the involved party. It is even possible to allow for third-party audits using the method of the present disclosure.

As an example, when creating a new transaction, randomized cryptographic credentials, e.g., a public/private key pair, may be created, e.g., uniquely for this transaction. Both, the material owner and the material recipient may create such randomized cryptographic credentials. The material owner and/or material recipient may store their respective credentials alongside the transaction ID, e.g. in a private data base. The credentials may be used specifically for signing and/or verifying this specific transaction. Examples for obtaining randomized cryptographic credentials may be creating a key pair may be key derivation or randomizable signatures. The above may be repeated for multiple transactions. Thus, a plurality of keys and the associated transaction IDs may be stored.

In yet another aspect, a use of a material transfer verified according to the method of the present disclosure for controlling the introduction of material into a production process is disclosed.

In yet another aspect, the present disclosure provides a computer element with instructions, which, when the instructions are executed on one or more computing node(s), cause an apparatus to carry out the steps of the method of the present disclosure or which are configured to be carried out by the apparatus of the present disclosure.

The present disclosure may also provide, in yet another aspect, a data processing system, particularly a distributed data processing system comprising a plurality of computing nodes, the data processing system, in particular one or more of the plurality of computing nodes, being configured to carry out the method of the present disclosure, particularly, in a distributed manner.

The present disclosure may also provide, in yet another aspect, a computer program product comprising instructions which, when the program is executed by a data processing system, cause the data processing system to carry out the method of the present disclosure. The data processing system may be a distributed data processing system comprising a plurality of computing nodes.

The present disclosure may also provide, in yet another aspect, a computer-readable medium comprising instructions which, when the program is executed by a data processing system, cause the data processing system to carry out the method of the present disclosure. The data processing system may be a distributed data processing system comprising a plurality of computing nodes.

The method and apparatus of the present disclosure allow for improved tracking and/or documenting of the transfer of materials in a decentral material network, particularly, may aid in overcoming challenges brought about by decentralization.

Specifically, the method and apparatus of the present disclosure make use of cryptographic methods and a distributed ledger application, such as a blockchain application, in a specific manner, i.e., representing an actual transfer of a material from a material owner to a material recipient as a transaction stored in the distributed ledger, and allowing for commitment, and optionally storing, of such transactions only under specific conditions.

The method and apparatus of the present disclosure make use of cryptographic methods and a distributed ledger application, such as a blockchain application, in a specific manner, i.e., representing an actual transfer of a material as a transaction stored in the distributed ledger, and allowing for multi-level access to data.

Even more specifically, as an example, it may be possible to perform a separation between data that allows for identifying flow of a material, e.g., a chemical substance, for example for mass balancing purposes and tracking purposes, while maintaining privacy as to specific data, e.g., carbon footprint or sustainability profile or origin data of the material being transferred in the course of the transfer corresponding to the transaction.

For example, material mass flows might thus be balanced on the basis of the material identifiers, whereas monitoring and/or balancing of carbon footprints or the like can be implemented in a separate process.

Many existing systems, e.g., smart-contract-based systems cannot reliably provide such separation.

Moreover, the present method allows for a reliable and non-complex way of accessing the correct material data set associated with the transaction. That is, if the transaction pointed directly to the material data set, this would be prone to errors, as it would have to be ensured that for each single transaction the correct, potentially unique, material data set is pointed to or linked to. Instead, among all material data sets in question, the correct one may be retrieved based on production data of the specific material, e.g., a batch ID or the like.

The present application allows for leveraging information stored in the transaction itself for mass balancing purposes. Moreover, it may allow, by selectively providing access to meta data to a party that allows for obtaining additional information.

The transaction may be related to exactly one material identifier and the relation between the material identifier, which is related with several material data sets, and the material data set associated with the transaction may be resolved using additional transaction meta data, like time stamp, production site, country of production, or the like.

The material data sets may not be stored as part of the distributed ledger, but may, for example, be stored in on or more databases.

Such material data sets may be retrieved using meta data from the transfer transaction. They may be shared between parties in a private channel.

As an example, the present disclosure may be used in a context where material flow occurs between multiple parties, also referred to as participants, of the decentral material network, where, without a central oversight, tracking and/or documenting the transfers reliably is challenging.

The commonly used implementation of a distributed system is either a hub-and-spoke system or a peer-to-peer system. Hub-and-spoke systems suffer from strong centralisation that give the hub owner either monopolistic power over all participating production and consumption nodes or lead to unwieldy, inept bureaucracy as all participants share ownership of the central hub (“shareholder democracy”).

As examples, in a distributed system, forecasting, planning, and steering of production and/or consumption nodes is required to achieve target values of system wide verifiable key performance indicators (KPIs). System wide KPIs may include, for example, annual reduction of greenhouse gas, GHG, emissions, annual increase of recycling quota, or the like.

These system wide KPIs contrast with local indicators valid only for a single pair of nodes. Local indicators increase the risk of, while achieving local successes, creating displacement effects or rebound effects, so that system performance gets worse overall while local performance is improving. Exemplary displacement effects include so-called “carbon leakage”, where GHG emissions increase in other producer countries, i.e., other parts of the network. Exemplary rebound effects comprise local production improvements which are overcompensated by increased overall consumption.

While decentral systems of the art, e.g., Peer-to-peer (P2P) networks, are good at steering such local KPIs, e.g., between material owner and material recipient, they face challenges in terms of system wide KPIs. P2P networks, for example, generally have no means to guarantee complete, uninterrupted supply chains without missing links, let alone verifiable mass balances of supply chains.

Examples of system wide KPIs to be improved by forecasting, planning, and steering may include:
Total emissions of the system (including GHG emissions and/or air, water, and/or land pollution),
Total recycling quota of the system, and
Environmental impact profile of the system, e.g., product carbon footprint (PCF) or aggregated PEF (Product environmental impact).

In view of the above, there is a need to provide methods aiding in improved tracking and/or documenting of the transfer of materials in a decentral material network, particularly, for allowing system wide performance assessment and, optionally, performance adjustment.

It is particularly advantageous that the method and apparatus of the present disclosure allows for verifiable and transparent tracking of material transfers, particularly reducing the risk of fraudulent recycling and sustainability claims or claims regarding material origins.

When providing reliable and verifiable tracking and/or documenting of the transfer of materials, particularly mass flows and/or mass balances, it is a concern that this might lead to complete transparency of material flows. However, it may be advantageous to make information available on a need-to-know basis, e.g., selectively providing information to selected parties only, e.g., due to privacy protection or the like. Generally, the data that should be more readily available may be such data that allows for verifiably tracking system wide KPI, e.g., for deriving recycling quotas, GHG emissions, throughput or flow rate in a material loop, consumption of virgin material in comparison to throughput, and/or rate of irretrievably lost material. The present method may allow for a significant degree of anonymization without impeding the reliable and verifiable tracking. For example, the use of cryptographic credentials, e.g., signatures and public/private keys is advantageous to that end. Said credentials may be validated for verifying material transfers.

The method and apparatus of the present disclosure may be used for these purposes and aid in overcoming challenges outlined above.

The method and apparatus of the present disclosure may be used for these purposes and aid in overcoming challenges outlined above. In particular, the method and apparatus of the present disclosure may be used in a circular process, particularly a closed material loop, represented in a decentral material network. Specifically, the method and apparatus may be used for tracking mass transfers and performing mass balancing. Mass balancing may entail tracking that the mass of material being transferred is consistent over all successive material transfers. In particular, it may be used for ensuring that material does not simply appear in a production process unless verified and committed to the distributed ledger as a transaction, e.g., a create transaction. This similarly applies to disappearing of material from a production process.

Use of the cryptographic credentials of the material owner as specified by the present disclosure allows for limiting eligibility of a material owner to have a transaction, particularly transactions of a certain type, committed to the distributed ledger.

For example, a material transfer transaction may be a create transaction. A create transaction may be a type of transaction that represent the introduction of a, e.g., raw or virgin, material into a production process. By means of the method of the present disclosure, limitations may be implemented as to which participant is a material owner eligible for a create transaction. Thus, it is possible to closely control any points of entry into the production process. This may be important because otherwise materials with uncertain properties or origin might be introduced, or materials associated with the transaction might be entirely made up. By controlling points of entry, only trusted parties might be able to introduce materials. Optionally, additional checks (in addition to the owner's eligibility) may be performed for committing a create transaction.

Another type of transaction may be an in-process transfer transaction, which may be any transaction that does not introduce material. Such a transaction may also be referred to as an owner-to-recipient transaction. Such a transaction may require a different, potentially lower, level of trust than a create transaction. For example, any material owner may, in principle, be eligible to have such a transaction committed to the distributed ledger, given that their cryptographic credentials are verified and optionally that additional checks are successfully performed. For example, admissibility of a transfer transaction to be committed to the ledger may be made dependent on plausibility checks, like mass balancing, ensuring that there is no undocumented appearance or disappearance of material. Some such additional plausibility checks may also be applied to create transactions, but particularly with respect to mass flow, some plausibility checks may not be applicable, as the create transaction does not have a (documented) preceding transaction.

According to the present disclosure, the material may be a discrete or indiscrete material.

According to the present disclosure, the material may be a chemical raw material.

According to the present disclosure, the material may be transferred in a linear production process or in a circular process. The method may, then, for example be used for tracking mass transfers, specifically mass balances. As an example, whether or not a material transfer is committed as a transaction may be determined based on boundary conditions related to material owner permission and/or mass flows.

According to the present disclosure, the material data may include transaction meta data and optionally the amount of the material transferred from the material owner to the material recipient. The transaction meta data may be used, for example, to retrieve from a database, e.g., a MongoDB database, more information concerning the transaction, specifically, the transferred material that is associated with the transaction.

The amount of material may be used for the purposes of determining mass flows, e.g., performing mass balancing. This information may be less sensitive than information related to the transferred material as well as the identity of the material owner and material recipient, such that for transparency purposes, e.g., mass balancing, it may be advantageous to have the amount of transferred material directly accessible as part of the transaction data. In terms of the other information, having it accessible not as part of the transaction, but, e.g., for retrieval from a database, may allow for improved access control and privacy. Particularly, this allows for sensitive data to be managed by a trusted party, e.g., that is deemed reliable and/or may be subject to audits, and also ensures reliable and continuous access to the information. Moreover, this allows to use a public distributed ledger because sensitive information, like material data and the identity of the material owner and material recipient, cannot be derived from the transaction data. However, knowing the identity of the material owner and/or the material recipient allows trusted parties to monitor material flows, such as waste material flows.

According to the present disclosure, the transaction meta data may include a material identifier, at least one material classification, material production data or a combination thereof.

As an example, the material production data may comprise one or more of a time stamp, a production site, a country of production, and a batch ID. This allows for efficient information access and retrieval, e.g. in a data base holding information of the transferred material, and may also allow for the participants of the transfer, but not necessarily any other parties, to access more information than is stored in the actual transaction.

Such meta data allows for efficiently retrieving information associated with the transaction, e.g., from a data base, particularly, such information that is unique to the transfer of material associated with the transaction.

It is, thus, possible, to keep exact track of a specific unit of material over the course of multiple transfer steps, processing steps, and the like, without having to pass on all of the previous history with each transaction. Thus, the transactions remain manageable in size, do not require particular means for protecting sensitive data, and can still provide reliable tracking.

According to the present disclosure, the material identifier may include a digital representation pointing to a material data set, e.g., a material passport, or parts thereof.

As an example, the digital representation pointing to a material data set may comprise a pointer, particularly a hash pointer, to a material data set, in particular, to a material passport associated with the material, particularly, identifying properties of the material.

According to the present disclosure, the material data set may be received from a data providing service. Specifically, the data providing service may ensure that the material data set has the proper configuration and content, and may, in particular, reliably ensure storage and/or secure access to the material data set.

According to the present disclosure, the material data set may further comprise a decentral identifier and data related to the material. The decentral identifier may be a unique identifier uniquely associated with the data owner and material data. Via the decentral identifier, particularly its unique association with the data owner and material data, access to the material data may be controlled by the data owner, rather than a central authority.

According to the present disclosure, the material data set may further include data related to one or more authentication mechanisms associated with the decentral identifier. Through the authentication mechanism data access by a data consuming service can be controlled in a secure manner and integrity of the data providing service can be ensured. This allows for more reliable, controlled and secure data exchange or sharing, as will also be understood from the terminology section below.

According to the present disclosure, the material data set may be related to one or more authorization mechanisms associated with the decentral identifier. Through the authorization mechanism data access and data usage by a data consuming service can be controlled in a secure manner, as will also be understood from the terminology section below.

According to the present disclosure, the data related to the material may include one or more digital representation(s) pointing to a material data set, also referred to as material property data, or parts thereof.

According to the present disclosure, the material data set (material property data) may comprise the material name, the material ID, the material composition, chemical and/or physical properties of the material, emission data of the material, recyclate content of the material, bio-based content of the material, further material production data, material declaration data, chemical material safety data, certificate of analysis data associated with the material, or a combination thereof.

Specifically, the material data set (material property data) may comprise data representative of a carbon footprint of a material.

According to the present disclosure, the cryptographic credential(s) of the material owner may include the public key, and optionally the private key and/or the cryptographic signature of the material owner.

As an example, in terms of the cryptographic signature, the material transaction request may be signed by the material owner using their private key. A validation of the signature may then be performed, e.g., using URI content.

According to the present disclosure, the cryptographic credential(s) of the material recipient may include the public key, and optionally the private key and/or the cryptographic signature of the material recipient. This allows for reliable verification.

According to the present disclosure, the confirmation of commitment or the denial of commitment of the material transaction request may be received by the requestor. Alternatively or in addition, the confirmation of commitment or the denial of commitment of the material transaction request may be received by the material owner and/or some other predetermined party. This may allow for parties to document, independently of the distributed ledger, whether a transfer of material was successfully verified and has been committed to, particularly stored in, the distributed ledger.

According to the present disclosure, validating the cryptographic credential(s) of the material owner may include retrieving a list containing cryptographic credential(s) and comparing the cryptographic credential(s) of the material owner with the cryptographic credential(s) contained in the retrieved list.

The list containing cryptographic credential(s) may, for example, be a whitelist or a blacklist of public keys.

As an example, a user who intends to participate in a material transfer may be required to store their ID together with their public key in a database. The database may then be used for creating and/or updating the list, e.g., the blacklist or the whitelist of public keys.

According to the present disclosure, the transfer of the material is verified if the cryptographic credential(s) contained in the material transaction request is/are not matching the cryptographic credential(s) contained in the retrieved list. This may be the case, for example, when the retrieved list is a blacklist.

For the sake of completeness, it is noted that the transfer of materials may, in particular, only be verified under the condition that the cryptographic credential(s) contained in the material transaction request is/are not matching the cryptographic credential(s) contained in the retrieved list. That is, in case the cryptographic credential(s) contained in the material transaction request is/are matching the cryptographic credential(s) contained in the retrieved list, the transfer may not be verified.

The above exemplifies the case where the retrieved list is a blacklist of public keys.

Alternatively, the cryptographic credential(s) may be verified if, particularly only if, the cryptographic credential(s) contained in the material transaction request is/are matching the cryptographic credential(s) contained in the retrieved list or another list. This would exemplify the case where the retrieved list or the other list is a whitelist of public keys.

There may be alternative or additional conditions that need to be met in order to verify a material transaction, as will be described further below.

According to the present disclosure, the distributed ledger may comprise material transactions, each material transaction being associated with a transfer of a material from a material owner to a material recipient, said material transactions including a transaction identity and material data associated with the material. The material transaction comprised in the distributed ledger may each be material transactions stored into the distributed ledger in response to committing the material transaction to the ledger as outlined above.

According to the present disclosure, validating the cryptographic credential(s) of the material owner may include, alternatively or in addition to retrieving the list containing cryptographic credential(s), retrieving a list containing transaction identities of material transactions and comparing the transaction identity associated with the received material transaction request with the transaction identities contained in the retrieved list.

The list containing transaction identities of material transactions may, for example, be a whitelist or a blacklist of transaction identities, e.g., similarly to the whitelist or blacklist of cryptographic credential(s).

The above, in particular, allows for retroactive sanctioning. For example, in case a transaction that should not have been committed to the distributed ledger, yet was not prevented by the safeguards, e.g., the use of the cryptographic credential(s), may be blocked from being the origin for subsequent transfer transactions. Such a transaction may be detected by means of the transaction identity and the above-mentioned list of transaction materials. Accordingly, additional safeguards against attacks and fraud may be provided that allow for retroactive measures.

According to the present disclosure, the transfer of the material may be verified if the transaction identity associated with the received material transaction request is not matching a transaction identity contained in the retrieved list.

For the sake of completeness, it is noted that the transfer of materials may, in particular, only be verified under the condition that the transaction identity associated with the received material transaction request is not matching a transaction identity contained in the retrieved list. That is, in case the transaction identity associated with the received material transaction request is matching a transaction identity contained in the retrieved list, the material transfer may not be verified.

This exemplifies the case where the retrieved list is a blacklist of transaction identities. Alternatively, a whitelist of transaction identities may be used for verification, similarly to the whitelist of public keys described above.

According to the present disclosure, validating the cryptographic credential(s) of the material owner may include validating the cryptographic signature of the material owner. The optional validating the cryptographic credential(s) of the material recipient may include validating the cryptographic signature of the material recipient.

That is, in order for being eligible for commitment, a material transaction request may be required to contain cryptographic credential(s) of the material owner and optionally the cryptographic credential(s) of the material recipient, in particular the cryptographic signature of the material owner and optionally the cryptographic signature of the material recipient, and validating the cryptographic credential(s) may be performed for the cryptographic credential(s) of the material owner and optionally for the cryptographic credential(s) of the material recipient.

The validating of the cryptographic credential(s) may be carried out as outlined above, for example. In particular, both, the cryptographic credentials(s), in particular cryptographic signature, of the material owner and the cryptographic credentials(s), in particular cryptographic signature, of the material recipient may be validated.

According to the present disclosure, the material transfer transaction may contain exactly one material identifier. Thus, each transaction may uniquely refer to only one material and its associated material data sets. This makes resolving the information easier and keeps the transaction lean.

According to the present disclosure, retrieving-based on the material identifier and material production data contained in the transaction meta data-the material data set associated with the transfer of the material may include determining a chemical substance associated with the material based on the material identifier contained in the meta data and retrieving the material data set associated with the transfer of the material based on the determined substance and the material production data.

A chemical substance may be any material with definite chemical composition and characteristic properties. As an example, the material may be at least one of ethanol, urea, sulfonic acid, hydrogen chloride, nitric acid, styrene, acrylic acid, hydrogen, propanol, butanol, butyl acetate, butyl acrylate, ethyl acrylate.

The at least two material data sets may, thus, for example, each be a data set containing data for a different specific batch of a chemical substance. Based on the material identifier in the transaction, it may be identified that the transfer of material related to a specific chemical substance, but not necessarily, to which batch of said substance. The material data set associated with the transfer of the material, e.g., of the specific batch of said substance being transferred, may be retrieved as outlined above, based on the material production data, which may, for example, be used for identifying the specific batch and/or the material data set associated therewith.

According to the present disclosure, the chemical substance may be associated with the material via a chemical registry number, in particular a CAS number.

The CAS number, also referred to as CAS registry number, is a unique identifier assigned by the Chemical Abstracts Service (CAS), to chemical substances, including organic compounds, inorganic compounds, minerals, isotopes, alloys, mixtures, and nonstructurable materials.

According to the present disclosure, the distributed ledger application may be stored on each member node of the distributed ledger.

According to the present disclosure, the distributed ledger application may be a smart contract. According to the present disclosure, the material identifier may include a pointer pointing to the digital representation of the chemical substance.

The pointer pointing to the digital representation of the chemical substance may be a pointer, particularly a hash pointer, to an identifier, e.g., registry number, of a chemical substance.

Any disclosure, embodiments, features, technical effects, and advantages described in the present disclosure in the context of the method also apply to the apparatus, the use, and the computer element of the present disclosure and vice versa. The benefits provided by any of the embodiments and examples equally apply to all other embodiments and examples and vice versa.

### TERMINOLOGY

In the following, terminology as used herein and/or the technical field of the present disclosure will be outlined by ways of definitions and/or examples. Where examples are given, it is to be understood that the present disclosure is not limited to said examples.

A material, in the present disclosure, is to be understood broadly as referring to one or more physical entities. A material may be discrete or indiscrete, e.g., may be a continuous volume of solid or liquid material in case of an indiscrete material or comprise a plurality of pieces, e.g., parts or components, in case of discrete material. A chemical material may be a chemical raw material, chemical processed material, or recycled material, for example.

Material, according to the present disclosure, may be categorized into at least the following material categories.

A raw material, in the present disclosure, may comprise a material that is an educt or starting material in a production process. It may be a virgin material or a reused material, e.g., a material having already gone through a production and use cycle.

A virgin material, according to the present disclosure, may comprise newly extracted raw material, in particular, material that has not undergone a production-and-use cycle, in particular, has not been processed and/or used. For example, it may not have undergone any of the second to sixth steps of a production process as described below.

A reused material, according to the present disclosure, may be a material that has already undergone a production-and-use cycle. For example, a reused material may be a material that has undergone, after use of the material, a treatment to prepare it for reuse. This may entail a processing step, e.g., recycling and/or other treatment steps, e.g., cleaning or the like.

A recycled material is an example of a reused material. It may be a material having undergone, after use of the material, one or more processing steps. The processing steps may be such steps that enable the material to be used as a raw material.

The present disclosure is concerned with the transfer of material.

The material may be transferred in the course of a production process, which, according to the present disclosure, may comprise a production stage and a use stage, e.g., use by the end consumer. The production process may comprise that the material, after use, is treated for reuse and enters another processing stage. Alternatively or in addition, the production process may comprise that the material is disposed.

In more detail, for example, a production process according to the present disclosure, may be a process that comprises at least a first step, also referred to as a feed step or material introduction step, wherein material is introduced into the production process, a second step, also referred to as a processing step, wherein material that has been introduced into the production process is processed, e.g., to obtain a product, and a third step, also referred to as a use step, e.g., comprising a use by an end customer.

In general, material may be transferred in a linear process, e.g., a linear production process, or in a circular process, which may comprise a production process.

The circular process, according to the present disclosure, is a process that comprises, in addition to the production stage and the use stage, a reuse stage. Accordingly, it may also comprise treating material for reuse. In particular, a circular process may comprise one or more, in particular all of the above described first step, second step, third step, also referred to as a use step, a fourth step, also referred to as a treatment for reuse, which may comprise, e.g., a recycling step and/or a cleaning step, and a fifth step, also referred to as a re-use step, which may be another processing step. Optionally, the circular process may comprise a sixth step, also referred to as a disposal step. Moreover, different cycles of the circular process may comprise different subsets of the above steps.

The steps may optionally be performed in this order.

Optionally, the fourth and fifth step may be repeated prior to performing the sixth step. Each of the first to sixth step may comprise a plurality of sub-steps.

In the course of the circular process, one or more materials may be involved, in particular, may be subject to one or more, in particular all, of the first to sixth step.

In the course of the circular process, material may be split up and/or merged with other material. The merging with other material may be seen as processing the material and as processing the other material.

Alternatively or in addition, in the course of the circular process, the one or more materials may be transferred between parties.

The circular process, may, in particular, be implemented as a closed material loop. A closed material loop, according to the present disclosure, may be a circular process, more specifically, a circular material flow, where virgin material is only fed into the circular process to replace unusable material, e.g., disposed material, and diffusive or accidental material losses to the environment, like attrition, abrasion, or irretrievable loss. Otherwise, no virgin materials are being fed/introduced into the closed material loop. The stream of virgin material fed into the circular process to replace disposed material and/or diffusive or accidental material losses may be referred to as a make-up stream of virgin material.

A linear process may comprise only the production stage, use stage, and disposal. In particular, it may not involve a reuse of material, particularly, may not involve any recycling and/or other treatment steps that prepare the material for reuse. In other words, raw material may not include material of the process itself, e.g., recycled or otherwise reintroduced material. As an example, a linear process may comprise the first to third, and sixth steps outlined above, but may not comprise the fourth step and fifth step outlined above.

In the present disclosure, the transfer of (a) material may refer to a material being transferred between one or more first parties, each also referred to as material owner, to one or more second parties, each also referred to as material recipient, in particular from the one or more first parties to the one or more second parties. A transfer of material may refer to an already performed as well as a projected or planned transfer of material from a first party to the one or more second parties. In particular, a transfer of material may comprise a material being transferred between exactly one first party and exactly one second party.

The one or more first parties and the one or more second parties, particularly the material owner and material recipient, may each comprise at least one of a legal person, e.g. a company, a natural person, and a collective of legal and/or natural persons.

A material owner may be a party having ownership of a material, particularly physical control over a material and/or economic ownership of a material. The material owner being party to a transfer of material is also referred to in the present disclosure as material owner associated with the transfer of material or vice versa.

A material recipient may be a party receiving ownership of a material, particularly physical control over a material and/or economic ownership of a material. The material recipient being party to a transfer of material is also referred to in the present disclosure as material recipient associated with the transfer of material or vice versa.

A transfer of material may comprise a transfer of ownership from the material owner to the material recipient, and may include at least one of a transfer of physical control over the material, also referred to in short as physical transfer of the material, and an economic ownership of the material. The material being transferred in the course of the transfer of material is also referred to as material associated with the transfer of material or vice versa.

The one or more first parties and one or more second parties are collectively referred to herein as parties involved with the transfer.

According to the present disclosure, material data, or in short data, associated with or related to the material may comprise, for example, transaction meta data and/or an amount of the material transferred in the course of the transfer of material. The material data may optionally comprise production data, e.g., time stamp, production site, country of production, a serial number (IBCs), a QR code, and/or a batch ID. Alternatively or in addition, the material data may optionally comprise a material data set (also referred to as data representative of one or more properties of the material), and/or one or more digital representation(s) pointing to a material data set or parts thereof.

A material data set may comprise the material name, the material ID, the material composition, chemical and/or physical properties of the material, emission data of the material, recyclate content of the material, bio-based content of the material, further material production data, material declaration data, chemical material safety data, certificate of analysis data associated with the material, or a combination thereof. A material data set associated with the transfer of material may be a data set that comprises the material data specifically associated with the material being transferred, e.g., with the specific batch concerned by the material transfer.

Particularly, it may not comprise material data that is not associated with the material being transferred or, in other words, may comprise only such material data that is associated with the material being transferred.

The term “material data set” is to be understood broadly in the present case and may comprise data related to a property of the material and/or data related to the use of the material. Such a property may be a static or a dynamic property. A static property may be a property constant over time e.g. melting point, boiling point, density, hardness, flammability or the like. A dynamic property may be a property that changes over time e.g. shelf life, pH value, color, reactivity. A property of the material may include performance properties, chemical properties, such as flammability, toxicity, acidity, reactivity, heat of combustion and/or physical properties such as density, color, hardness, melting and boiling points, electrical conductivity or the like. Data related to the use of the material may include data related to further processing of the material, for example by using the material as reactant in further chemical reaction(s) and/or data related to the use of the material, for example data related to the use of the material in a treatment process and/or within a manufacturing process. The material data set may include chemicals data, emission data, recyclate content, bio-based content and/or production data.

Transaction metadata may be seen as data representative of transferred material. Transaction metadata may include one or more of a material identifier, at least one material classification, and material production data. The material identifier may, for example, include a digital representation pointing to a material data set or parts thereof, in the present disclosure, to at least two different material data sets. For example, the transaction itself may, according to the present disclosure, not comprise any specific details on the material associated with the material transfer. This may ensure, for example, that the transaction may be made public while keeping details on the material being transferred and the involved parties private. As a more specific example, a transaction may comprise transaction data comprising the digital representation pointing to the material data set or parts thereof. In addition, the transaction data may comprise one or more of the type of transaction, e.g., create or transfer transaction, one or more public keys, such as the public key of the material owner and material recipient, an ID, and the amount of material being transferred.

The term “digital representation(s) pointing to material data or parts thereof” is to be understood broadly in the present case and may comprise at least one interface to a data providing service.

It may further include at least one interface to a data consuming service. It may include an endpoint for data exchange or sharing (resource endpoint) or an endpoint for service interaction (service Endpoint), that is uniquely identified via a communication protocol. The digital representation(s) pointing to material data or parts thereof may hence be uniquely associated with the decentral identifier.

According to the present disclosure, a material data set may be received from a data providing service. The term “data providing service” is to be understood broadly in the present case and comprises computer-executable instructions for providing and/or processing data, such as material data, associated with the data owner for accessing and/or processing by a data consuming service.

A material data set, according to the present disclosure, may comprise a decentral identifier and data related to the material. Optionally, the material data set may comprise data related to an authentication mechanism associated with the decentral identifier. Alternatively or in addition, the material data set may be related and/or comprise data related to one or more authorization mechanisms associated with the decentral identifier.

The term “decentral identifier” may be understood broadly in the present case and may comprise any unique identifier uniquely associated with the data owner and material data. The decentral identifier may include a Universally Unique IDentifier (UUID) or a Digital IDentifier (DID). The decentral identifier may be issued by a central or decentral identity issuer. The decentral identifier may include authentication information. Via the decentral identifier and its unique association with the data owner and material data access to the material data may be controlled by the data owner. This contrasts with central authority schemes, where identifiers are provided by such central authority and access to data is controlled by such central authority.

Decentral in this context may refer to the usage of the identifier in implementation as controlled by the data owner.

In the present disclosure, the material data set may include one or more authentication mechanisms associated with the decentral identifier and the data related to the material data.

The authentication mechanism may include a token, such as private and public key infrastructure, a certificate mechanism or a biometric mechanism, such as fingerprints, face recognition or voice recognition or the like. One common public key certificate is for instance the X.509 certificate. Through the authentication mechanism data access by a data consuming service can be controlled in a secure manner and integrity of the data providing service can be ensured. This allows for more reliable, controlled and secure data exchange or sharing.

The one or more authentication mechanisms associated with the decentral identifier as generated by one central node or by one or more decentral nodes may be provided to a node generating the material data set and to at least one decentral authentication data registry, preferably accessible by the data providing service and/or the data consuming service. The authentication data registry may be a central registry such as a central file system, a centrally managed distributed database, and/or a centrally managed peer-to-peer network. The central configuration allows for higher control and standardization via a central node. The authentication data registry may be a decentral registry such as a distributed ledger, a decentralized file system, a distributed database, and/or a peer-to-peer network. The decentral configuration allows for more efficient use of computing resources and strengthens control over the material data set by the data owner.

In the present disclosure, the material data set may be related to or include one or more authorization mechanisms associated with the decentral identifier and the data related to the material data. The authorization mechanisms may include authorization rule(s) including data transaction instructions or data transaction protocols, such as data usage policies, smart data contracts or more complex data processing instructions associated with data providing and/or data consuming services. Through the authorization mechanism, data access and data usage by a data consuming service can be controlled in a secure manner.

The one or more authorization mechanisms associated with the decentral identifier as generated by one central node or by one or more decentral nodes may be provided to a node for generating or processing the material data set or for accessing the data related to the material data. Additionally or alternatively, the one or more authorization mechanisms may be provided to at least one central or decentral authorization data registry, preferably accessible by the data providing service and/or the data consuming service. In one embodiment the one or more authorization mechanisms associated with the decentral identifier as generated by one or more decentral nodes may be provided to a node generating or processing the material data set and to at least one of a central file system, a centrally managed distributed database, a centrally managed peer-to-peer network, a distributed ledger, a decentralized file system, a distributed database, and/or a peer-to-peer network, preferably accessible by the data providing service and/or the data consuming service.

In the present disclosure, a material transfer transaction, also in short referred to as a material transaction, is to be understood as a digital representation, particularly a unique digital representation, of a transfer of material from a first party to one or more second parties, particularly from exactly one first party to exactly one second party. The material transfer transaction is also referred to in the present disclosure as being a material transfer transaction associated with the transfer of material or vice versa. Accordingly, the material associated with the transfer of material may also be referred to as the material associated with the material transfer transaction or vice versa. More specifically, the material transfer transaction may be a transaction stored in a distributed ledger.

A material transfer transaction request, also in short referred to as a material transaction request, according to the present disclosure may comprise an instruction to commit the material transfer transaction request as material transfer transaction to the distributed ledger. The request may, in particular, be a request to commit the material transfer request as a material transaction to a distributed ledger, and optionally store the material transfer transaction in the distributed ledger. This material transfer transaction is also referred to as being associated with the material transfer transaction request or vice versa.

The material transfer transaction request may be created and/or transmitted by a requesting party, also referred to as requestor, e.g., to a distributed ledger application. The material transfer transaction and/or material transfer transaction request, according to the present disclosure may be referred to as being associated with a material or vice versa.

The material transfer transaction request may comprise material data. That is, the material data may be stored in the material transfer transaction associated with the material transfer transaction request.

The material transfer transaction request may alternatively or in addition comprise data indicating a material transfer transaction. For example, the data indicating a material transfer transaction may comprise data representative of the identity of the transfer transaction, also referred to as transaction identity. Such data may be any data, including an identifier or the like, that uniquely identifies a material transfer transaction in a given context, e.g., in a given distributed network.

In the present disclosure, commitment of the material transfer transaction request as transaction to a distributed ledger may, for example, comprise instructions to store the transaction in the distributed ledger. For example, the material transfer transaction is received and validated at member node, also called receiving node of the distributed ledger. The receiving node may store validated requests in a database and may assign the validated requests to one or more other nodes running a consensus algorithm, such as a BTF (byzantine fault tolerant) consensus protocol. These one or more other nodes may process the assigned requests by creating an ordered list of transactions from the assigned requests, create blocks for said transactions and store the blocks in a database. Each created block has a reference to a parent block such that a blockchain results. Other member nodes running the consensus algorithm vote whether they consider a block valid or invalid by checking the validity of every transaction in the block. If such a node finds an invalid transaction, then it votes that the block is invalid, otherwise it votes that the block is valid. Once there is majority of positive (valid) votes for a block, voting on the block stops and the block is committed to the blockchain. Otherwise, the block is rejected and is not committed to the blockchain.

In the present disclosure storing or storage of a transfer transaction may, for example, comprise that the transfer transaction is stored in a distributed ledger, for example added as a block to the distributed ledger. In one example, the decision to add the transfer transaction to the distributed ledger is made by consensus, i.e. the majority of member nodes of the distributed leger must agree that the transaction is valid as previously described.

Storage of a transaction in the distributed ledger may be triggered by commitment of the transfer transaction request as transaction to the distributed ledger. Accordingly, storage of the transaction may be performed in response to the commitment, except when an error occurs. A confirmation of commitment of a request, e.g. the material transaction request, may comprise an indication that the commitment is authorized, which may imply that the commitment has been or will be performed. In particular, the confirmation of commitment may comprise an indication that the commitment has been successfully performed.

Transmitting or receiving confirmation of commitment of a request as transaction to a distributed ledger may entail transmitting or receiving information, in particular comprised in a message, indicating that the request has been and/or will be committed as transaction to the distributed ledger.

Transmitting or receiving denial of commitment of a request, e.g., as transaction to a distributed ledger, may entail transmitting or receiving information, in particular comprised in a message, indicating that the request has not been and will not be committed, e.g., as transaction to the distributed ledger.

Verifying a transfer of material may comprise determining, based on data associated with the transfer of the material, for example data associated with the material, the material owner and/or the material recipient, and/or data associated with the material transaction request, and based on a predetermined rule or set of rules, whether the transfer of material to be registered in the distributed ledger is going to be or has already happened between the parties.

Verifying the transfer of material may comprise validating cryptographic credential(s) of the material owner associated with the transfer of material and/or the cryptographic credential(s) of the material recipient associated with the transfer of material. For example, the cryptographic credentials may be contained in the material transaction request associated with the transfer of material.

Cryptographic credentials may comprise data establishing the identity of a party of a communication. Cryptographic credentials may take the form of machine-readable cryptographic keys, for example public keys and/or private keys and/or cryptographic signatures and/or passwords and/or passphrases. Cryptographic credentials may be self-issued, or issued by a trusted third party. A cryptographic credential may be configured so as to establish an unambiguous association of the cryptographic credential with a specific, real individual or other entity. Cryptographic credentials may optionally be configured to expire after a certain period of time, although this is not mandatory. An X.509 public key certificate is an example of a cryptographic credential.

Validating cryptographic credentials may comprise matching of cryptographic credentials with a list of credentials, particularly a curated list. Such lists may include a blacklist and/or a whitelist of credentials. Validation of a cryptographic credential may be successful in case the cryptographic credential is matched or not matched with a credential on the list of credentials, e.g., when it is matched with a credential on a whitelist or when it is not matched with a credential on a blacklist.

In the context of the present disclosure, validating cryptographic credentials may also comprise, e.g. instead or in addition to matching the cryptographic credentials to a list of credentials, matching a transaction identity of a material transfer transaction comprising or associated with the cryptographic credentials, with a list of transaction identities. Validation of a cryptographic credential may be successful in case the transaction identity is matched or not matched with a transaction identity on the list of transaction identities, e.g., when it is matched with a transaction identity on a whitelist or when it is not matched with a transaction identity on a blacklist.

Computer implemented methods may, for example, relate to a decentral material network comprising a distributed ledger, as is the case in the present application. The distributed ledger may be seen as a shared, replicated, and synchronized database among member nodes of a decentralized network, such as a P2P network. In general, a distributed ledger may record transactions between participants of the network and may, thus, provide an immutable history of transactions.

Updates of the distributed ledger may be performed based on a consensus algorithm. When an update occurs, all nodes update themselves with the proper updated copy of the ledger.

Blockchain applications are a specific example of a distributed ledger application. The nature of the distributed ledger is that there is no centralized authority, e.g., a clearing house.

The distributed ledger, more specifically, the transactions thereof, may represent material flows in a material network like a production or supply chain, e.g., introducing of material into a material network or transfer of material within the material network. In that case, the distributed ledger may allow for searching transactions, which in turn may enable lookup across multiple intermediate steps in the material network, e.g., the supply chain, which may ensure traceability of material flow and accountability of each material owner and recipient.

A distributed ledger may comprise a distributed ledger application, as is the cases in the present disclosure. The distributed ledger application performs computing steps associated with the distributed ledger.

The distributed ledger application may be stored on each member node of the distributed ledger.

As an example, the distributed ledger application may be a smart contract. A smart contract may be a computer program or a transaction protocol that automatically executes and/or controls and/or documents events and/or actions according to an agreement, e.g. a contract.

For example, the computer program or transaction protocol may automatically carry out steps in response to predetermined conditions derived from and/or laid down in the agreement being met.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### BRIEF DESCRIPTION OF THE DRAWINGS

In the following, the present disclosure is further described with reference to the enclosed figures:

FIG. 1a illustrates example embodiments of a centralized computing environment with computing nodes.

FIG. 1b illustrates example embodiments of a decentralized computing environment with computing nodes.

FIG. 1c illustrates an example embodiment of a distributed computing environment. shows an example of a distributed ledger. FIG. 2

FIGS. 3A, 3B illustrate an example embodiment of the present disclosure.

FIG. 4 is a flow chart illustrating an example embodiment of the method according to the present disclosure.

FIGS. 5A to 5E illustrate potential applications of the method of the present disclosure.

FIG. 6 shows an example of material data set including DID owner data, DID document data and decentral identity infrastructure.

FIG. 7 shows an example of a material data set including ID-based data, data of a material data set, and decentral identity infrastructure.

FIG. 8 illustrates an example of a production facility producing a chemical product associated with a material data set.

FIG. 9 illustrates another example of a production facility producing a chemical product associated with a material data set.

FIG. 10 illustrates an example of a production system producing a chemical product associated with one or more material data set(s).

FIG. 11 illustrates an example embodiment of the present disclosure.

FIGS. 12A-12B are flow charts illustrating example embodiments of the method according to the present disclosure.

FIG. 13 illustrate an example embodiment of the present disclosure.

FIGS. 14A-14D are a flow charts illustrating example embodiments of the method according to the present disclosure.

### DETAILED DESCRIPTION OF EMBODIMENTS

The following embodiments are mere examples for implementing the method, the system or application device disclosed herein and shall not be considered limiting.

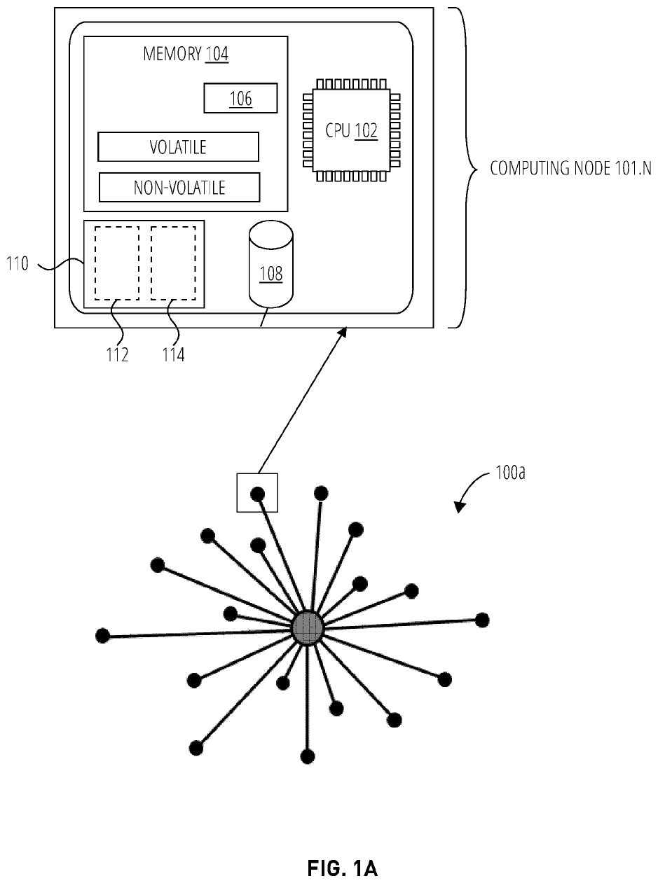

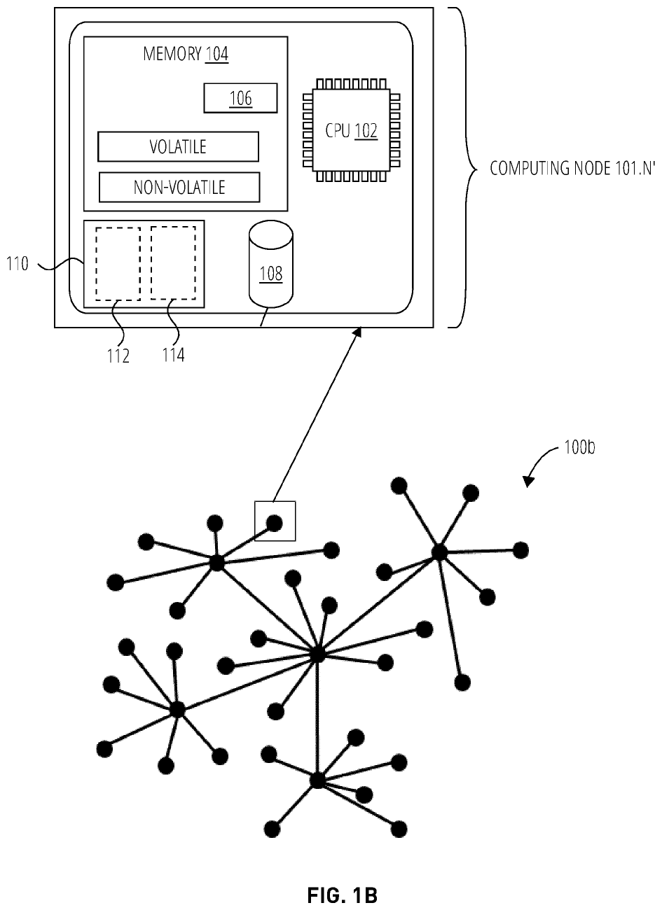

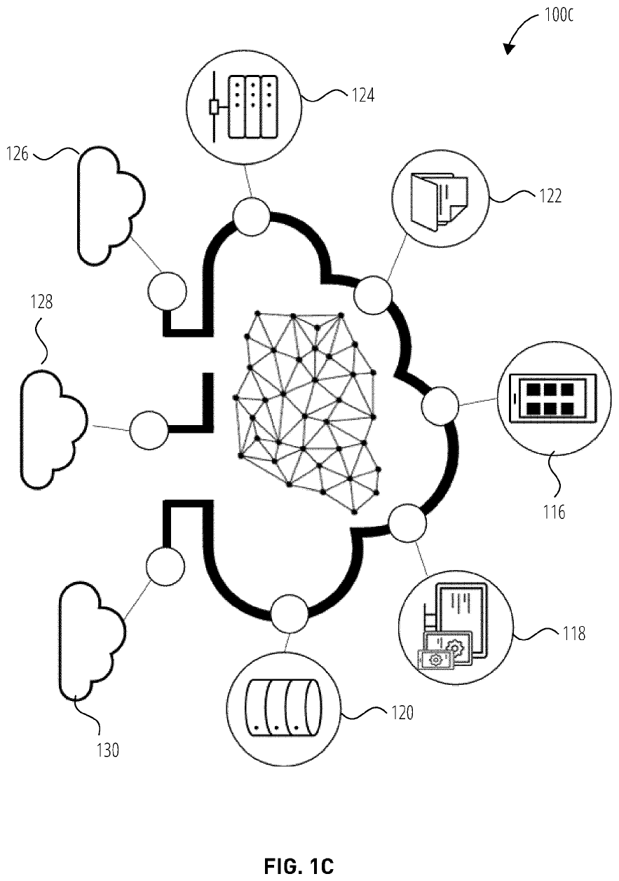

In order to provide context for the method and apparatus according to the present disclosure, different computing environments, central, decentral and distributed, are illustrated in FIGS. 1a to 1c and described herein below.

The methods, apparatuses, computer elements of this disclosure are implemented in decentral or at least partially decentral computing environments, specifically, a decentral network, which may reflect the decentral nature of material transfers between multiple independent parties.

FIG. 1a illustrates an example embodiment of a centralized computing system 100 comprising a central computing node 101 (filled circle in the middle) and several peripheral computing nodes 101.1 to 101.n (denoted as filled circles in the periphery).

The term “computing system” is defined herein broadly as including one or more computing nodes, a system of nodes or combinations thereof. The term “computing node” is defined herein broadly and may refer to any device or system that includes at least one physical and tangible processor, and a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 101.1 to 101.n may be connected to one central computing system (or server). In another example, the peripheral computing nodes 101.1 to 101.n may be attached to the central computing node via e.g. a terminal server (not shown). The majority of functions may be carried out by, or obtained from the central computing node (also called remote centralized location). One peripheral computing node 101.n has been expanded to provide an overview of the components present in the peripheral computing node.

The central computing node 101 may comprise the same components as described in relation to the peripheral computing node 101.n.

Each computing node 101, 101.1 to 101.n may include at least one hardware processor 102 and memory 104. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semiconductor-based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 104 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 101, 101.1 . . . 101.n may include multiple structures 106 often referred to as an “executable component or computer-executable instructions”. For instance, memory 104 of the computing nodes 101, 101.1 . . . 101.n may be illustrated as including executable component 106. The term “executable component” may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.n, whether such an executable component exists in the heap of a computing node 101, 101.1 . . . 101.n, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.n (e.g., by a processor thread), the computing node 101, 101.1 . . . 101n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 102 of each computing node 101, 101.1 . . . 101.n direct the operation of each computing node 101, 101.1 . . . 101.n in response to having executed computer-executable instructions that constitute an executable component. For example, such computer-executable instructions may be embodied on one or more computer-readable media that form a computer program product. The computer-executable instructions may be stored in the memory 104 of each computing node 101, 101.1 . . . 101.n. Computer-executable instructions comprise, for example, instructions and data which, when executed at a processor 101, cause a general purpose computing node 101, 101.1 . . . 101.n, special purpose computing node 101, 101.1 . . . 101.n, or special purpose processing device to perform a certain function or group of functions. Alternatively or in addition, the computer-executable instructions may configure the computing node 101, 101.1 . . . 101.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.n may contain communication channels 108 that allow each computing node 101.1 . . . 101.n to communicate with the central computing node 101, for example, a network (depicted as solid line between peripheral computing nodes and the central computing node in FIG. 1a). A “network” may be defined as one or more data links that enable the transport of electronic data between computing nodes 101, 101.1 . . . 101.n and/or modules and/or other electronic devices. When information is transferred or provided over a network or another communications connection (either hardwired, wireless, or a combination of hardwired or wireless) to a computing node 101, 101.1 . . . 101.n, the computing node 101, 101.1 . . . 101.n properly views the connection as a transmission medium. Transmission media can include a network and/or data links which can be used to carry desired program code means in the form of computer-executable instructions or data structures and which can be accessed by a general-purpose or special-purpose computing nodes 101, 101.1 . . . 101.n. Combinations of the above may also be included within the scope of computer-readable media.

The computing node(s) 101, 101.1 to 101.n may further comprise a user interface system 110 for use in interfacing with a user. The user interface system 110 may include output mechanisms 110A as well as input mechanisms 110B. The principles described herein are not limited to the precise output mechanisms 110A or input mechanisms 110B as such will depend on the nature of the device. However, output mechanisms 110A might include, for instance, displays, speakers, displays, tactile output, holograms and so forth. Examples of input mechanisms 110B might include, for instance, microphones, touchscreens, holograms, cameras, keyboards, mouse or other pointer input, sensors of any type, and so forth.

FIG. 1b illustrates an example embodiment of a decentralized computing environment 100′ with several computing nodes 101.1′ to 101.n′ denoted as filled circles. In contrast to the centralized computing environment 100 illustrated in FIG. 1a, the computing nodes 101.1′ to 101.n′ of the decentralized computing environment are not connected to a central computing node 101 and are thus not under control of a central computing node. Instead, resources, both hardware and software, may be allocated to each individual computing node 101.1′ . . . 101.n′ (local or remote computing system) and data may be distributed among various computing nodes 101.1′ . . . 101.n′ to perform the tasks. Thus, in a decentral system environment, program modules may be located in both local and remote memory storage devices. One computing node 101′ has been expanded to provide an overview of the components present in the computing node 101′. In this example, the computing node 101′ comprises the same components as described in relation to FIG. 1a.

FIG. 1c illustrates an example embodiment of a distributed computing environment 103. In this description, “distributed computing” may refer to any computing that utilizes multiple computing resources. Such use may be realized through virtualization of physical computing resources.

One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 103 may contain the following computing resources: mobile device(s) 114, applications 116, databases 118, data storage 120 and server(s) 122. The cloud computing environment 103 may be deployed as public cloud 124, private cloud 126 or hybrid cloud 128. A private cloud 124 may be owned by an organization and only the members of the organization with proper access can use the private cloud 126, rendering the data in the private cloud at least confidential. In contrast, data stored in a public cloud 126 may be open to anyone over the internet. The hybrid cloud 128 may be a combination of both private and public clouds 124, 126 and may allow to keep some of the data confidential while other data may be publicly available.

As explained in detail above, the method and apparatus of the present disclosure may make use of a distributed ledger. An exemplary distributed ledger 200 is shown in FIG. 2.

A distributed ledger 200 is a shared, replicated, and synchronized database among member nodes 202 of a decentralized network, such as a P2P network. A distributed ledger application performs computing steps associated with the distributed ledger. In general, a distributed ledger may record transactions between participants of the network and may, thus, provide an immutable history of transactions. Updates of the distributed ledger are performed based on consensus algorithm. When an update occurs, all nodes update themselves with the proper updated copy of the ledger. Blockchain applications are a specific example of a distributed ledger application. The nature of the distributed ledger is that there is no centralized authority, e.g., a clearing house.

A distributed ledger, more specifically, the transactions thereof, may represent material flows in a material network like a supply chain, e.g., introducing of material into a material network or transfer of material within the material network. In that case, the distributed ledger may allow for searching transactions, which in turn may enable lookup across multiple intermediate steps in the material network, e.g., the supply chain, which may ensure traceability of material flow and accountability of each material owner and recipient.

In FIG. 2, as a specific example, each node is shown as having a database layer 204a, also referred to as Database API, and a distributed ledger control layer 204b, which includes the distributed consensus algorithm and serves as a distributed ledger anchoring, e.g., blockchain anchoring. Providing separate layers may be advantageous, as database functions are geared at high throughput, e.g., for data loading and retrieval, access and querying, whereas distributed ledger functions usually provide lower throughput, yet ensure data immutability, tamper resistance, evidence, decentralized consensus over state, and replication of state across diverse nodes. However, a separation into separate layers is optional.

A distributed ledger as illustrated in FIG. 2, may be configured such that the database access and query commands on each node are implemented as part of the database layer and only few essential database commands may be implemented by the control layer.

As an example, when it comes to material flow being represented by the distributed ledger, the control layer may implement a CREATE transaction and a TRANSFER transaction, the CREATE transaction representative of feeding or introducing material into a material network and a transfer transaction representative of material being transferred within the material network from a material owner to a material recipient.

The CREATE transaction may, for example, write an asset object to the ledger and add a pointer to corresponding metadata and the TRANSFER transaction may, for example, implement “append-only” write operations to the ledger that have to reference one or more input transactions (CREATE or TRANSFER) and one or more outputs (destination addresses).

Accordingly, with only two transaction types, even distributed tracking and documenting of material flow in the material network and, particularly, mass balancing of the material, may be performed in distributed consensus.

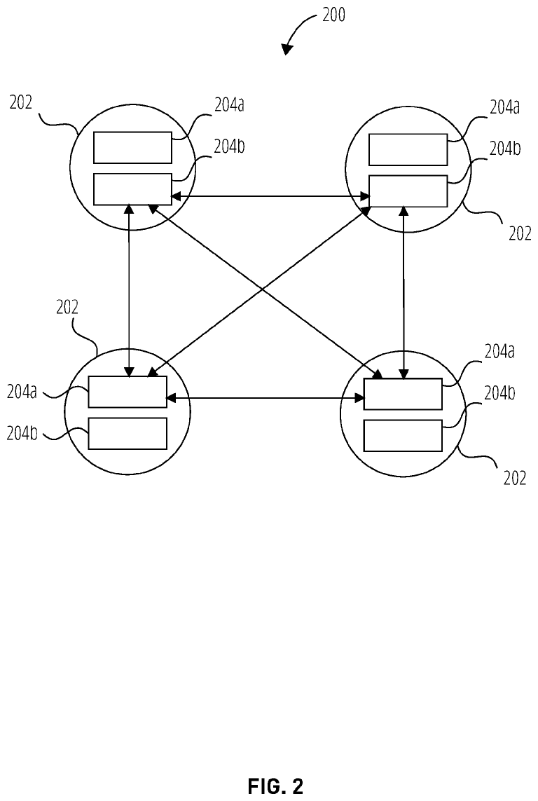

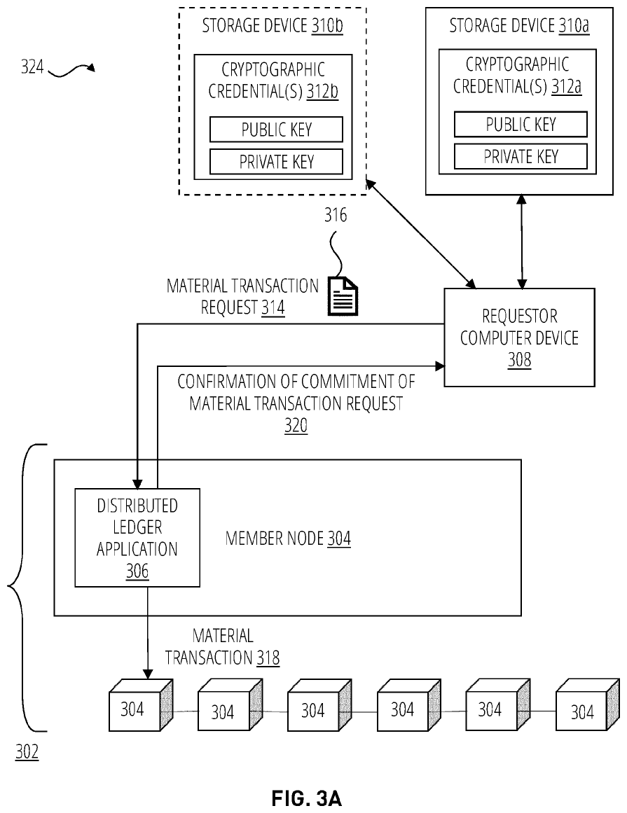

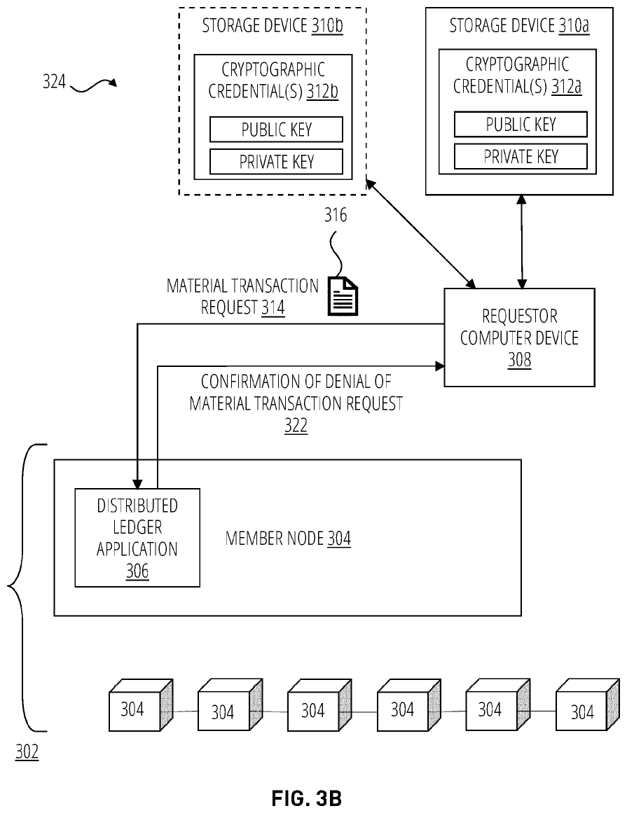

FIGS. 3A and 3B show block diagrams illustrating a method for verifying a transfer of a material between a material owner and a material recipient in a decentral network comprising a distributed ledger 302 that includes multiple member nodes 304 and a distributed ledger application 306 according to the present disclosure. Only one of the member nodes is shown in detail for the sake of simplicity. The member node is in communication with a requestor computer device 308, also referred to in short as requestor, e.g., via a data connection.

The requestor computer device is in communicative communication, e.g., via another data connection, with a storage device 310a on which cryptographic credential(s) 312a of the material owner are stored. The requestor device is configured to retrieve, from the storage device, the cryptographic credential(s) of the material owner.

Optionally, the requestor device may be configured to also retrieve, from the storage device 310a or from a different storage device 310b with which it is in communicative communication, cryptographic credential(s) 312b of the material recipient. The requestor computer device is configured to transmit a material transaction request 314 to the member node, specifically, to the distributed ledger application.

The material transaction request contains material data 318 associated with the material transfer which is to be verified. Moreover, the material transaction request comprises at least the cryptographic credential(s) of the material owner. Optionally, the material transaction request may also comprise the cryptographic credential(s) of the material recipient.

The distributed ledger application is configured to receive the material transaction request from the requestor computer device and to verify the transfer of the material.

The verifying the transfer of the material is performed by validating the cryptographic credentials of at least the material owner and optionally of the material recipient contained in the material transaction request.

FIG. 3a illustrates the scenario where the transfer of the material is successfully verified. If this is the case, the material transaction 318 is committed to and, optionally, stored in the distributed ledger. Moreover, the member node, specifically the distributed ledger application, transmits a confirmation 320 of commitment of the transaction request as a transaction to the requestor computer device. In addition, in the same or a different step, success of storage of the transaction in the distributed ledger may also be transmitted to the requestor computer device.

FIG. 3b illustrates the same system as FIG. 3a. In FIG. 3b the scenario where the transfer of material is not verified is shown. A transmission of denial 322 of commitment of the transaction request as transaction is in this case performed by the member node, specifically the distributed ledger application, to the requestor computer device. Moreover, as the transfer of material is not verified, the material transaction request is also not committed to nor stored as a transaction in the distributed ledger. The decentral network is designated with reference sign 324 in FIGS. 3a and 3b.

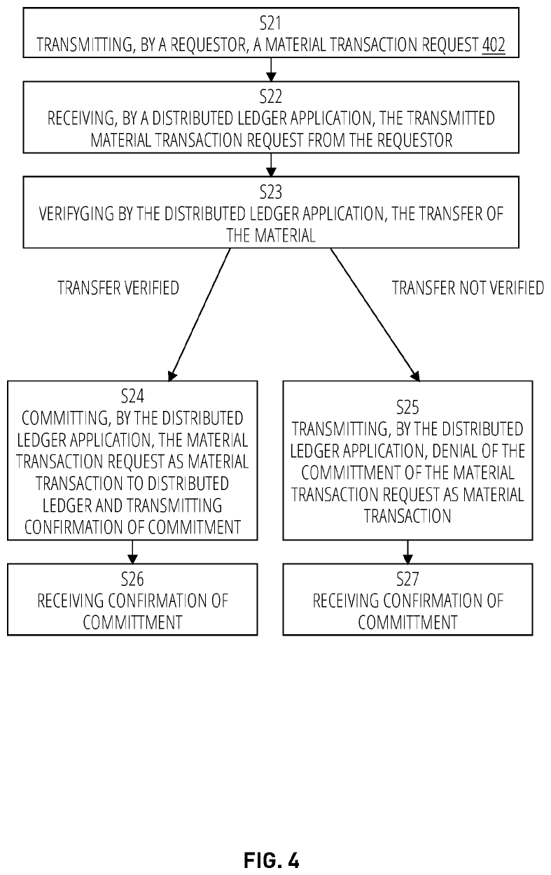

FIG. 4 is a flow chart illustrating the computer-implemented method of the present application. In step S21, a material transaction request is transmitted by a requestor. The material transaction request comprises material data associated with the material and cryptographic credentials of the material owner and optionally the material recipient.

In step S22, the material transaction request is received by the distributed ledger application from the requestor.

In step S23, the distributed ledger application verifies the transfer of the material by validating the cryptographic credentials of the material owner and optionally of the material recipient.

If the credentials are successfully verified, in step S24, the material transaction request is committed as a material transaction in the distributed ledger and confirmation of commitment of said material transaction request is transmitted by the distributed ledger application.

If the credentials are not successfully verified, in step S25, a denial of commitment of the material transaction request as a material transaction is transmitted by the distributed ledger application.

In step S26, confirmation of commitment of the material transaction request is received, for example by the requestor.

In step S27, denial of commitment of the material transaction request is received, for example by the requestor.

According to the present disclosure, material transactions may comprise different types of transactions. For example, a material transfer transaction may be a create transaction. A create transaction may be a type of transaction that represent the introduction of a, e.g., raw or virgin, material into a production process. By means of the method of the present disclosure, limitations may be implemented as to which participant is a material owner eligible for a create transaction. Thus, it is possible to closely control any points of entry into the production process.

For example, there may be whitelists or blacklists of parties eligible to have create transactions committed to the distributed ledger. It is noted that a create transaction will not have a preceding transaction within the chain of transactions. Accordingly, some checks, for example of mass balances or the like, that may be applied within the chain of transactions cannot be applied for a create transactions, which makes it all the more important to allow create transactions only for trustworthy parties.

Another type of transaction may be an in-process transfer transaction, which may be any transaction that does not introduce or dispose of material. These transactions will have preceding transactions. This may, for example, allow for performing mass balancing and ensuring that material does not simply appear or disappear.

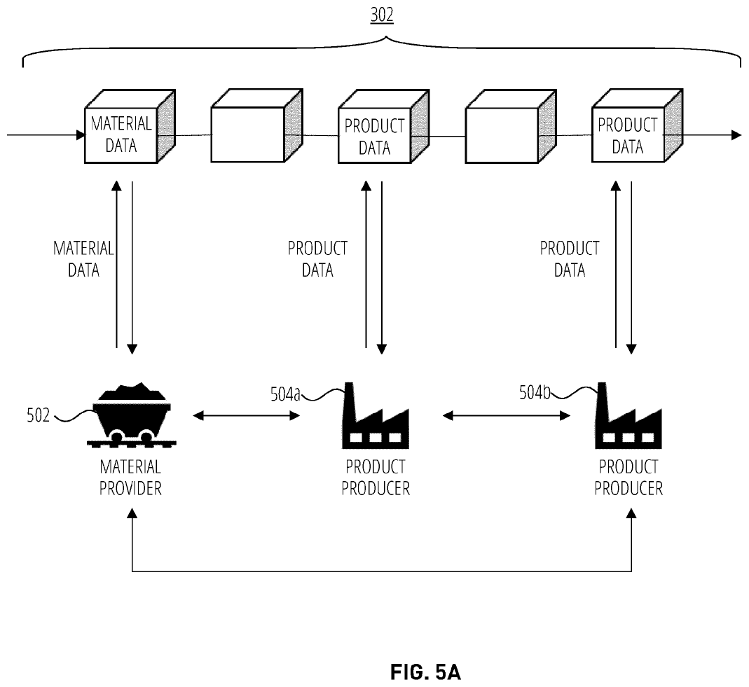

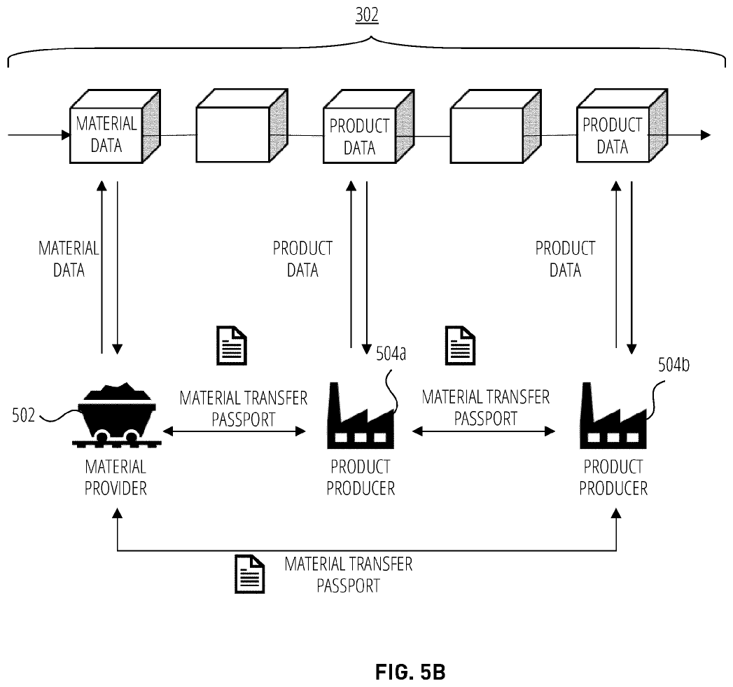

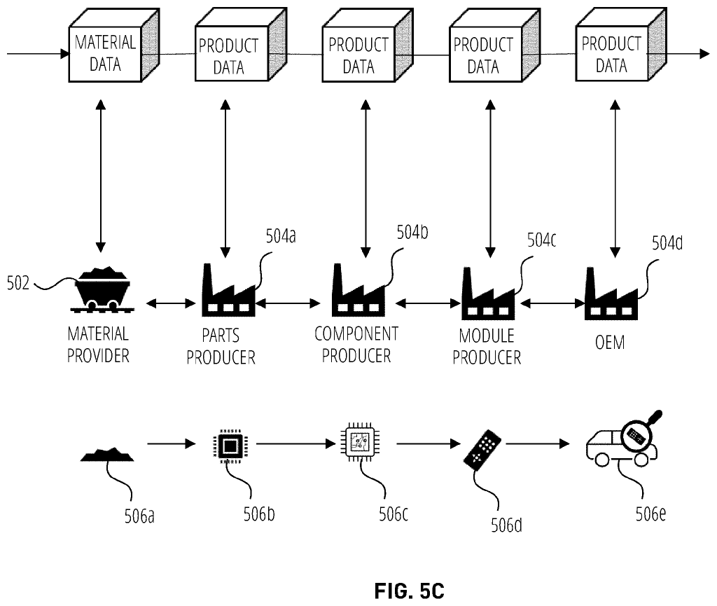

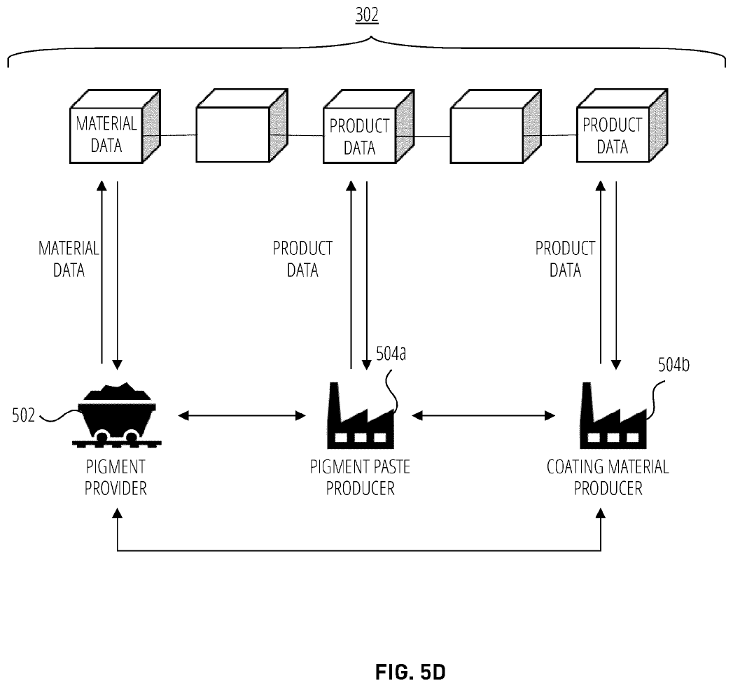

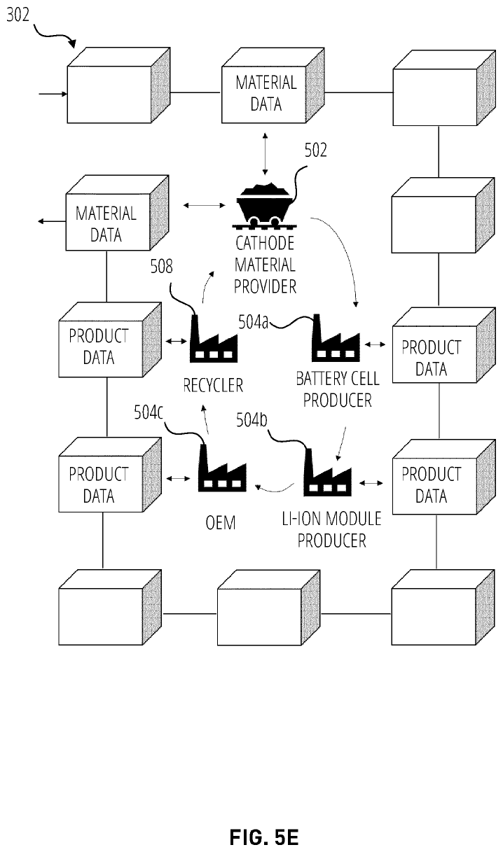

In FIGS. 5A to 5E, different examples illustrating potential applications of the method of the present disclosure in a material network, e.g., a supply chain, are shown.

The participants in the examples may comprise one or more of a material providers 502, one or more product producers 504, for example a parts producer 504a, a component producer 504b, a module producer 504c, or an original equipment manufacturer, OEM, 504d, and one or more recyclers 508.

FIG. 5A illustrates, in general, an information flow, e.g. of data labelled “material data” and data labelled “product data”, the product data being a specific type of material data relating to products which comprise the material, e.g., in processed or unprocessed form. Specifically, the material provider may provide material data to the distributed ledger and each product producer may provide product data to a distributed ledger 302. Additionally, information may be retrieved, by each of the participants, from the distributed ledger and/or information may be exchanged between different participants.

FIG. 5B is similar to FIG. 5A and shows the specific case where information exchanged between participants may comprise transfer of a material data set.

FIG. 5C is also similar to FIG. 5A. In this specific case, the participants comprise a material provider, a parts producer, and a component producer, a module producer, and an OEM. The material flow of the material 506, part 506a, component, 506b, module 506c, and original equipment 506d are also illustrated in FIG. 5C. It is to be understood that at least a portion of the material 506 is found in the part, component, module, and original equipment.

In the example shown in FIG. 5D, for example, the participants include a material provider, specifically a pigment provider, and two product producers, i.e., a pigment past producer and a coating material producer.

In the example shown in FIG. 5E, for example, the participants comprise a material provider, specifically a cathode material provider, two product producers, specifically a battery cell producer and a Li-Ion module producer, an OEM, and a recycler.

Although in FIGS. 5A to 5E each participant is shown as being able to perform a two-way exchange of data with the distributed ledger and the other participant, it is to be understood that this may not necessarily be the case. For example, data exchange may not be implemented for all possible data exchange routes or, by means of access control or the like, data exchange routes may be selectively closed for some participants.

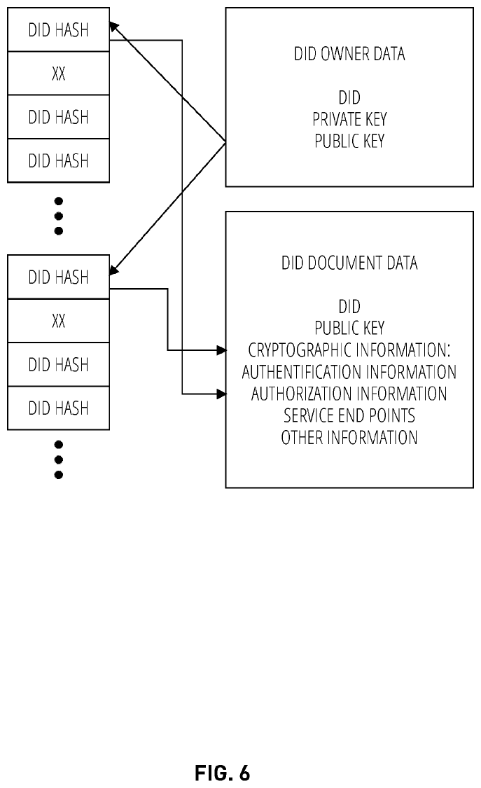

FIG. 6 shows an example of ID-based owner data, ID-based data, which may be at least partially comprised in a material data set like a material passport, and a decentralized identity manager.

The ID may be a decentralized ID (DID). The ID-based material data set may be a DID document associated with the DID. The ID-based owner data may include an ID associated with a subject such as product data or chemical product data and may include authentication mechanisms. The ID-based owner data may include owner data that is electronically owned and controlled by the DID owner. In this context electronically owned may refer to data that is stored in an owner repository or wallet. Such data may be securely stored and/or managed on an organizational server or client device. The ID-based owner data may include a DID, a private key and a public key. The ID-based owner may own and control the DID that represents an identity associated with the DID subject, a private key and public key pair that are associated with the DID. DID may be understood as an identifier and authentication information associated with or uniquely linked to the identifier.

The DID subject may be a raw material, a basic substance, a chemical product, an intermediate product, a component, a component assembly or an end product. The DID subject may be a machine, a system, or a device used for producing the raw material, the basic substance, the chemical product, the intermediate product, the component, the component assembly or the end product, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce chemicals. The DID owner may be a downstream participant in the supply chain of the chemical manufacturer such as a customer that consumes chemicals to produce the intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the DID subject and/or the DID owner. Preferably, the identifier is unique to the DID subject and/or DID owner. The identifier may be unique at least within the scope in which the DID is anticipated to be in use. The identifier may be a locally or globally unique identifier for the raw material, the precursor, the basic substance, the chemical product, the intermediate product, the component, the component assembly, the end product or a collection thereof; the machine, the system, or the device used for producing the raw material, the basic substance, the chemical product, the intermediate product, the component, the component assembly or the end product, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did: example: ebfeb1f712ebc6f1c276e12ec21. The DID may be decentralized independent of a centralized, third party management system and under the control of the DID owner.

The material data set as DID document may be associated with the DID. Accordingly, the material data set may include a reference to the DID, which is associated with the DID subject that is described by the DID document. The DID document may also an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The material data set may include one or more representations that digitally link to the product data or chemical product data, e.g. by way of service endpoints. A service endpoint may include a network address at which a service operates on behalf of the DID owner. In particular, the service endpoints may refer to services of the DID owner that give access to product data or chemical product data. Such services may include services to read or analyze product data or chemical product data. Chemical product data may include chemical product declaration data, chemical product safety data, certificate of analysis data, emission data, product carbon footprint data, product environmental footprint data, chemical product specification data, product information, technical application data, production data or combinations thereof.

The material data set may include various other information such metadata specifying when the material data set was created, when it was last modified and/or when it expires.

The DID and material data set may be associated with a data registry node such as a centralized data service system or a decentralized data service system, e.g. a distributed ledger or blockchain. Possible blockchain systems include Quorum, Hyperledger Fabric. The distributed ledger or blockchain may be used to store a representation of the DID that points to the material data set. A representation of the DID may be stored on distributed computing nodes of the distributed ledger or blockchain. For example, DID hash may be stored on multiple computing nodes of the distributed ledger and point to the location of the material data set. In some embodiments, the material data set may be stored on the distributed ledger. Alternatively, in other embodiments the DID document may be stored in a data storage (not illustrated) that is associated with the distributed ledger or blockchain.

The distributed ledger or blockchain may be any decentralized, distributed network that includes various computing nodes that are in communication with each other. For example, the distributed ledger may include a first distributed computing node, a second distributed computing node, a third distributed computing node, and any number of additional distributed computing node. The distributed ledger or blockchain may operate according to any known standards or methods for distributed ledgers. Examples of conventional distributed ledgers that correspond to the distributed ledger or blockchain include, but are not limited to, Bitcoin [BTC], Ethereum, and Litecoin.

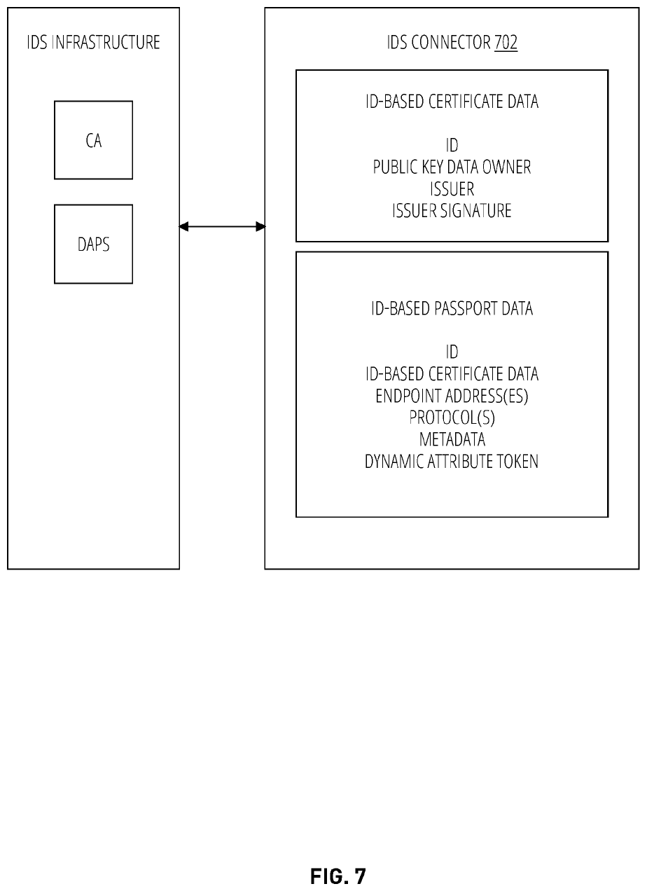

FIG. 7 shows an example of ID-based certificate data, an ID-based material data set and an identity manager.

In contrast to the example of FIG. 6, the example of FIG. 7 is certificate based. ID-based certificate data may include authentication data of the certificate owner and the certificate issuer. For example, a cryptographic signature from the issuer may bind the public key of the data owner to the ID. The ID may be a unique ID (such as UID) as described in relation to the DID of FIG. 6. The certificate may be a X.509 certificate such as X509v3. The ID-based material data set may be associated with the data source of the data owner. The ID-based material data set may include an ID, authentication data and endpoints associated with product data or chemical product data. Such endpoints may include any digital representation connecting to the data source. The data source may provide product data and/or chemical product data.

In this certificate-based example, the ID-based material data set includes one or more certificate(s) associated with the data owner. The certificates may be associated with an identity manager including e.g. a certificate issuing service and/or a dynamic provisioning service providing dynamic attribute tokens (e.g. OAuth Access Tokens). The information required to verify the certificates are provided via an authentication registry associated with the certificate issuing service and/or a dynamic provisioning service. For instance, in the IDSA Reference Architecture Model, Version 3.0 of April 2019, a connector associated with the data owner, a Certification Authority (CA), a Dynamic Attribute Provisioning Service (DAPS) and a connector associated with the data consumer service are used to verify the identity prior to performing a data exchange (not shown). For this purpose, such connectors include one or more certificate(s) such as X.509 certificate(s). This way the connector possesses a unique identifier embedded in a X.509 certificate that identifies the connector instance.

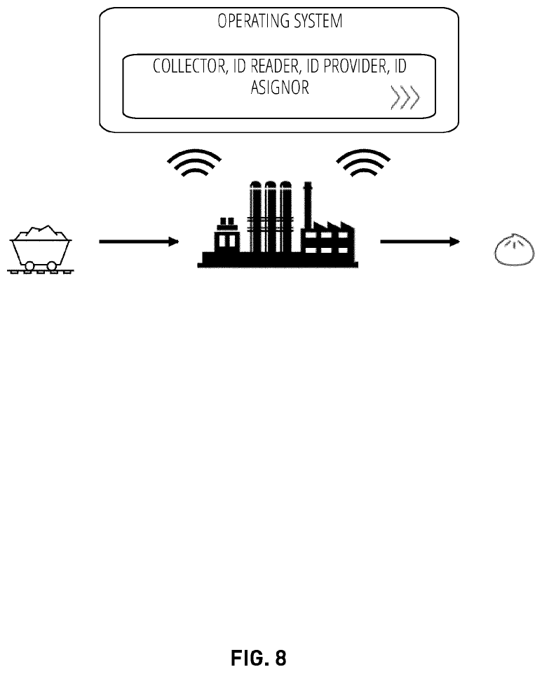

FIG. 8 illustrates one example of a production facility producing a chemical product associated with a material data set.

The production facility illustrated in FIG. 8 may manufacture the chemical product. The production facility may manufacture, e.g., an organic chemical product obtained by reacting organic chemical reactants. The production facility may include one or more production plants.

For example, the production facility for manufacturing the chemical product may include at least one precursor/intermediate product production plant.

The physical inputs to the production facility may include materials, such raw materials, intermediate materials or components to be assembled. Raw materials may be virgin or recycled raw materials.

The physical inputs may be associated with the decentral identifier as described above. The physical input(s) may be registered with the production facility. The registration may include providing the decentral identifier associated with the physical inputs. Providing the decentral identifier may include reading the physical identifier element physically connected to the physical input as described above. Providing the decentral identifier may include accessing a data base with decentral identifiers and fetching the decentral identifier associated with the physical input.

Based on the provided decentral identifier, chemical product data associated with such decentral identifier may be accessed. Access may be granted through authentication and authorization based on authentication and authorization information associated with the decentral identifier. Based on the decentral identifier, chemical product data such as chemical product declaration data, chemical product safety data, certificate of analysis data, emission data, product carbon footprint data, product environmental footprint data, chemical product specification data, product information, technical application data, production data, performance data, quality data, material configuration data, recyclate content data or combinations thereof may be accessed. Chemical product data may be accessed through a data service requesting access to the chemical product data associated with each decentral identifier and controlled by a physical input data owner. Data owner may be the producer of the physical inputs. The data service may include computer executable instructions operating in an at least partially decentral computing environment. Such computer executable instructions may be based on a Json Web Token (JWT) including authentication information, authorization information and/or a digital representation pointing to chemical product data or parts thereof. The digital representation may include an endpoint for data exchange or sharing (resource endpoint) or an endpoint for service interaction (service endpoint), that may be uniquely identified via a communication protocol. The digital representation(s) pointing to chemical product data or parts thereof may be uniquely associated with the decentral identifier. Chemical product data may be used for the manufacturing process of the production facility.

The production facility may produce the physical output based on one or more physical input(s). The physical output of the production facility may be associated with a physical identifier. The physical output of the production facility may be physically connected to a physical identifier element as described above. The physical identifier may be assigned to identifier information associated with the decentral identifier. For such assignment, the physical identifier element may be read or a data base with physical identifiers may be accessed. A request to provide a decentral identifier may be triggered to assign the physical identifier to the decentral identifier.

This way, the decentral identifier may be assigned to the physical output. Providing the decentral identifier may include accessing a data base with decentral identifiers and associated information such as authentication information. Providing the decentral identifier may include accessing a decentral service to provide the decentral identifier and associated information such as authentication information. In response to the request, the material data set including the decentral identifier and data related to the chemical product data of the chemical product may be generated. The data related to the chemical product data may include a representation such as a pointer or a link to the chemical product data. The decentral identifier may be associated to data related to the chemical product data of the physical output. The decentral identifier may further be related or assigned or linked to the decentral identifier of the physical input. The material data set may be provided to a decentral network for access by other participants or producers of the network. This way the chain of input to output material may be made traceable and usable in further manufacturing steps without exposing the chemical product data in an uncontrolled manner.

The process steps described above may be executed via an operating system of the production facility. In this embodiment, the operating system includes a collector configured to collect chemical product data and/or physical identifiers as described above. The collector may be configured to collect chemical product data associated with the chemical product or chemical product data associated with the production of the chemical product, wherein the chemical product is connected to or comprises the physical identifier. The operating system may in particular include an ID reader configured to provide the physical identity of physical input(s) or output(s) as described above. The system may further include an assignor configured to assign the decentral identifier and associated information to the physical output as described above. Further the operating system may include an ID provider configured to provide the decentral identifier and associated information as described above.

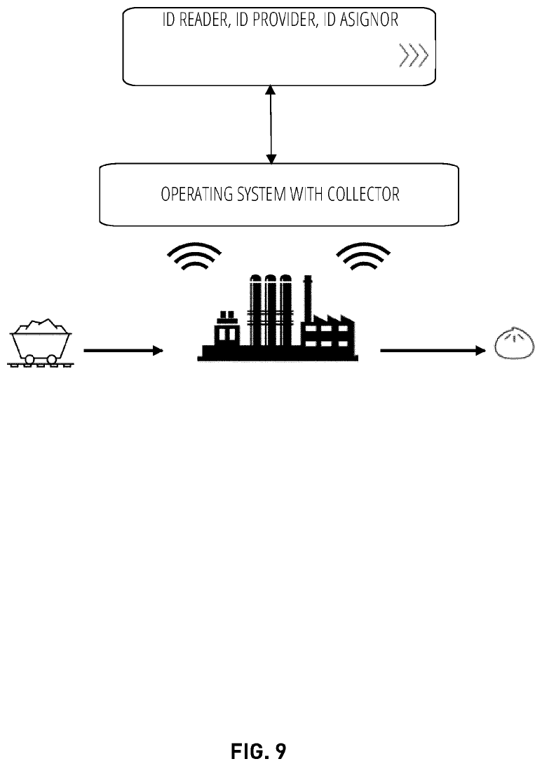

FIG. 9 illustrates another example of a production facility producing a chemical product associated with a material data set.

The process steps described in the context of FIG. 8 may be executed via an operating system of the production facility in interaction with the assignor, the collector or reader or the ID provider. In this embodiment, the operating system may be communicatively connected to the production facility and the assignor, the collector, the ID reader or the ID provider. The operating system may be configured to provide chemical product data from the production facility. The operating system may include a collector configured to provide chemical product data from the production facility. The operating system may include the ID reader configured to read the physical identifier element physically connected to the physical input or output. The assignor may be configured to assign the decentral identifier and associated information to the physical identifier of the physical output as described above in the context of FIG. 8. The ID provider may be configured to provide the decentral identifier and associated information as described above in the context of FIG. 8. The ID reader may be configured to provide the physical identity and associated information of physical input(s) or output(s) as described above in the context of FIG. 8. The assignor, the collector, the ID reader and/or the ID provider may be configured as decentral services or applications executed via the decentral network.

FIGS. 8 and 9 only show two example embodiments and any combination of the system components shown in FIGS. 8 and 9 may be possible. For instance, the ID reader may be configured as part of the operating system, while ID provider and assignor may not be configured as part of the operating system.

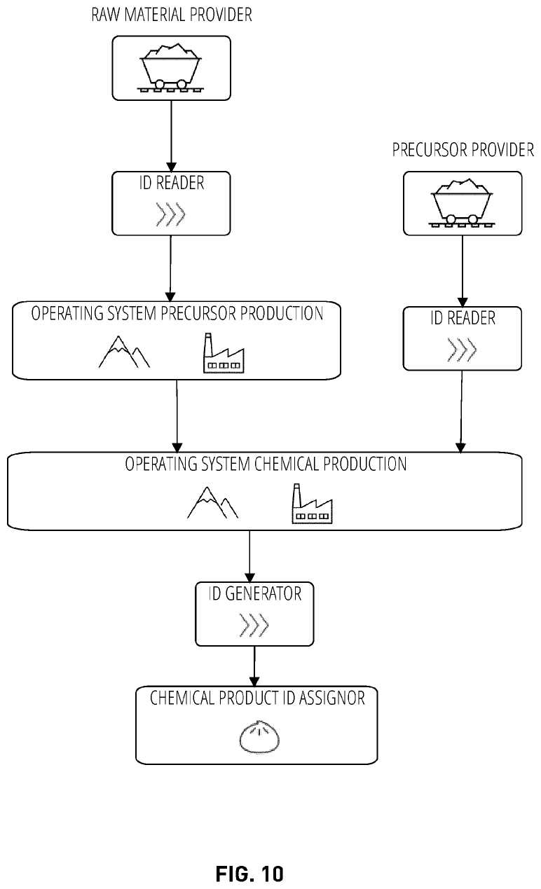

FIG. 10 illustrates an example for tracking material in the production of a chemical product from raw materials to the end product. FIG. 10 specifically illustrates an example for tracking material in the production of a chemical product.

For producing a chemical product raw materials may be provided as physical inputs. The raw materials may comprise precursor materials. The raw materials may include virgin or recycled materials. The raw materials may be associated with a decentral identifier. The decentral identifier may be associated with a digital twin of the raw materials. The decentral identifier may be associated with raw materials data such as a tag for virgin or recyclate material, material properties related to their environmental impact or material properties associated with their origin.

The production of a chemical product may comprise a two-step process: 1) production of precursor material, 2) production of the chemical product. To produce the precursor material, the raw materials may be used as physical inputs. The operating system of the precursor production may access data related to the raw materials based on the decentral identifier e.g. from a raw materials provider. Such data may be used to operate the production. For instance, if the raw materials are recycled materials, production steps purifying the recyclate may be comprised. For instance, if the raw materials are virgin materials, purification steps may be omitted. The precursor material may be formed by co-precipitating the raw materials. Production data from precursor production may be stored and/or associated with a decentral identifier.

In a second step, the precursor material may be provided to produce the chemical product. The precursor material may comprise the precursor produced by the precursor production. The precursor material may comprise recycled precursor material or precursor material produced by a different entity. Such precursor material may be associated with a decentral identifier via which data related to the precursor material may be accessible.

The produced and packaged chemical product may be assigned to a decentral identifier and associated information as lined out above. The packaged electrode active material may, for instance, comprise the physical identifier element, such as a QR-Code, physically attached to the package. Such physical identifier element may be assigned to the decentral identifier. The assignment of physical identifier element and decentral identifier may be executed through an ID generator/assignor running locally, in a decentral system and/or in a distributed system.

For instance, the packaging line may comprise a detector detecting the physical identifier on each package. Based on such recognition the operating system of the chemical product production may request to provide a decentral identifier and the provided decentral identifier may be assigned to the physical identifier. In response to the request, the material data set including the decentral identifier and data related to the chemical product may be generated.

For such generation, data related to the chemical product as recorded prior and/or during production of the chemical product may be gathered or accessed. Such data may be provided by the operating system of the chemical product production, or a storage environment connect to the operating system of the chemical product production. This may include data collected and stored during precursor material production.

The data related to the chemical product may include the identifier of raw materials used to produce the chemical product. The data related to the chemical product may include the data related to the raw material as e.g. accessible via the decentral identifier of the raw materials.

The data related to the chemical product may include data related to the material configuration of the chemical product. The material configuration data may relate to the chemical composition of the chemical product. The material configuration data may specify at least one constituent of the chemical composition of the chemical product.

The data related to the chemical product may include data related to properties related to environmental impact such as CO₂ footprint or recyclate content. For instance, the data related to the chemical product may specify recyclate content for the components or raw materials.

Such recyclate content may either be directly associated with the decentral identifier of the chemical product or it may be indirectly associated with the decentral identifier of the chemical product, e.g. via the decentral identifier of the raw materials or the precursor materials. The data related to the chemical product may include data related to the production conditions as provided by the operating system of the chemical product production. The data related to the chemical product may include data related to the operation conditions as provided by the operating system of the chemical product production. The data related to the chemical product may include data related to the producer, such as producer name, producer brand or producer identifier. The data related to the chemical product may include data related to the product, such as product name, product brand or product identifier.

FIGS. 8 to 10 illustrate examples of providing access to data via one or more material data set(s).

Via the decentral setup described above, different supply chain participants or producers up to end consumers may access data from supply chain participants or producers. Access to such data may include transferring the data to the requester or processing the data and transferring the processed result to the requester.

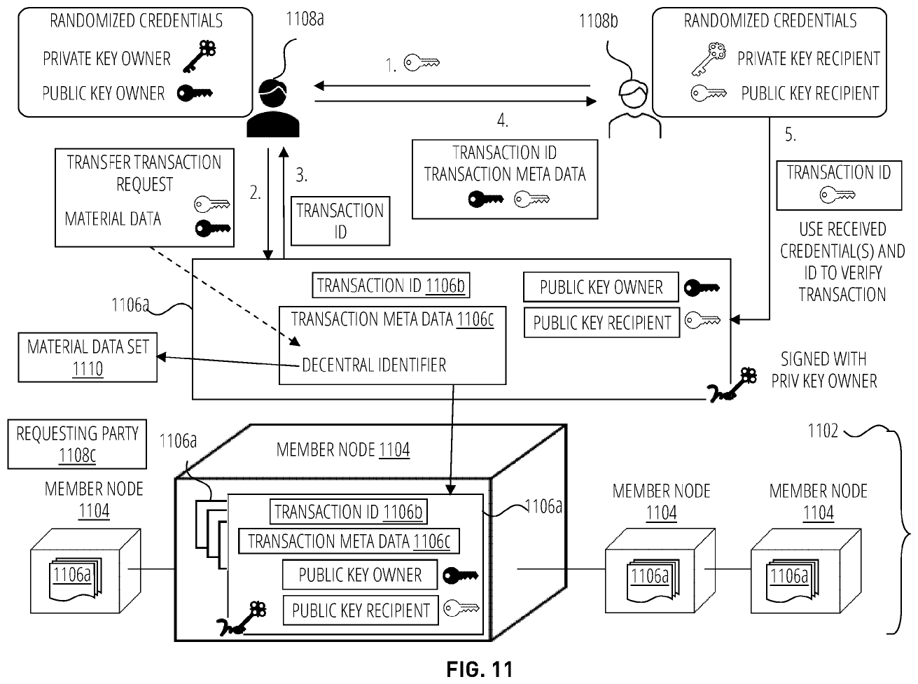

FIG. 11 shows a block diagram illustrating a method for verifying a transfer of a material from a material owner to a material recipient in a decentral network comprising a distributed ledger 1102 that includes multiple member nodes 1104 according to the present disclosure. Only one of the member nodes is shown in detail for the sake of simplicity.

As shown in FIG. 11, on each of the member nodes of the distributed ledger, transactions 1106a are stored. One transaction is shown in detail. Included in the transaction is a transaction ID 1106b and transaction meta data 1106c. The transaction meta data comprises a decentral (material) identifier in the present example. The material identifier is related to one or more material data sets 1110, as indicated by an arrow in FIG. 11. The transaction meta data may comprise additional data, e.g., material production data, which is not shown for the sake of simplicity.

Also shown in FIG. 11 are a material owner 1108a, also referred to as owner, and a material recipient 1108b, also referred to as recipient.

In FIG. 11, randomized credentials associated with the owner and the recipient are also shown, as an example, a respective private key and public key pair of each of the owner and the recipient. The recipient may provide their public key to the material owner. The material owner may then send a transfer transaction request, in the present example comprising material data, the public key of the owner and the public key of the recipient.

A transaction may then be created. The transaction may also, optionally, be signed using the (transaction-specific) private key of the owner.

In the present example, the public keys of material owner and recipient are included in the transaction. Moreover, transaction metadata, e.g., obtained from the material data of the transfer transaction request, may be included in the transaction.

The transaction also comprises a transaction ID, which uniquely identifies the transaction, and is provided to the owner. The owner provides, to the material recipient, the (transaction-specific) public key(s) of the owner and optionally the recipient used for creating the transaction, the transaction ID, and optionally transaction metadata.

The material recipient or a third party may use the transaction ID and the/one of the public keys received from the owner and verify that the transaction with said transaction ID and key(s) is stored in the public ledger.

Additionally or alternatively, the recipient or a third party may determine, based on the (transaction-specific) public key of the owner, whether the transaction was signed with the owner's private key. For example, the owner's signature in the transaction may correspond to that of a message received from the owner.

As the credentials are unique to the transaction and their association with a specific party to the transfer is only known to the parties involved to the transaction and documented off-chain, a high degree of privacy as to the concerned parties can be provided, particularly, as the randomization does not even allow for any conclusions from pattern-analysis. At the same time, the concerned parties or an audit being given access to the information indicative of identities of the involved parties may perform additional verification that require knowledge of the identities of the parties associated with the transaction.

It is noted that the decentral identifier comprised in the transaction meta data may be used by a requesting party 1108c to retrieve a material data set that is associated with the specific material transfer associated with the transaction. In some cases, additional data, e.g., material production data, included in the transaction meta data may be used to retrieve the material data set. As an example, the decentral identifier may identify a chemical substance and, among multiple material data sets associated with the material identifier, the material data set associated with said specific transfer may be selected and retrieved using said additional data. For example, each of the material data sets may comprise data pertaining to a separate batch of the chemical substance. While the decentral identifier may indicate that the transaction is associated with the transfer of said chemical substance, based on the additional data, e.g., material production data, the material data set of a specific batch of said substance may be retrieved, i.e., the material data set of the batch being transferred in the transfer of material.

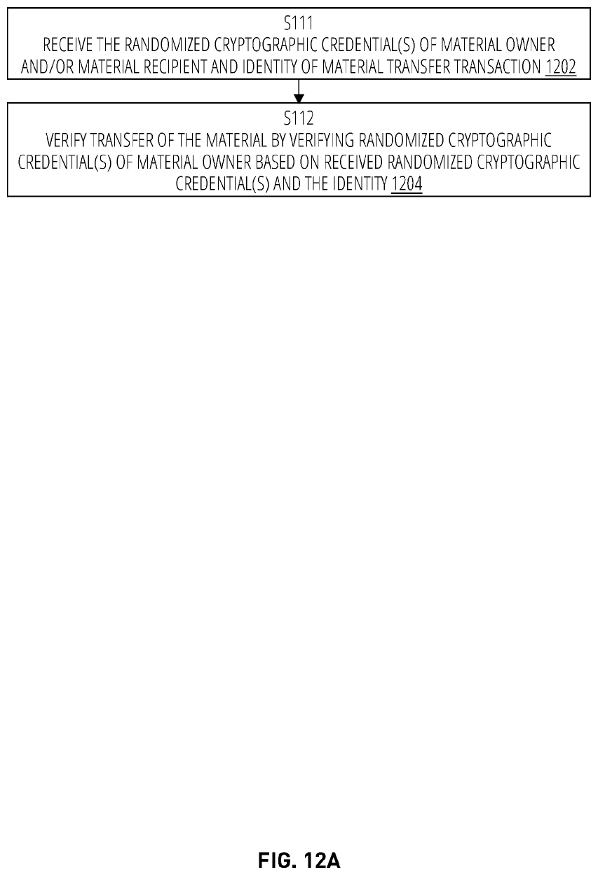

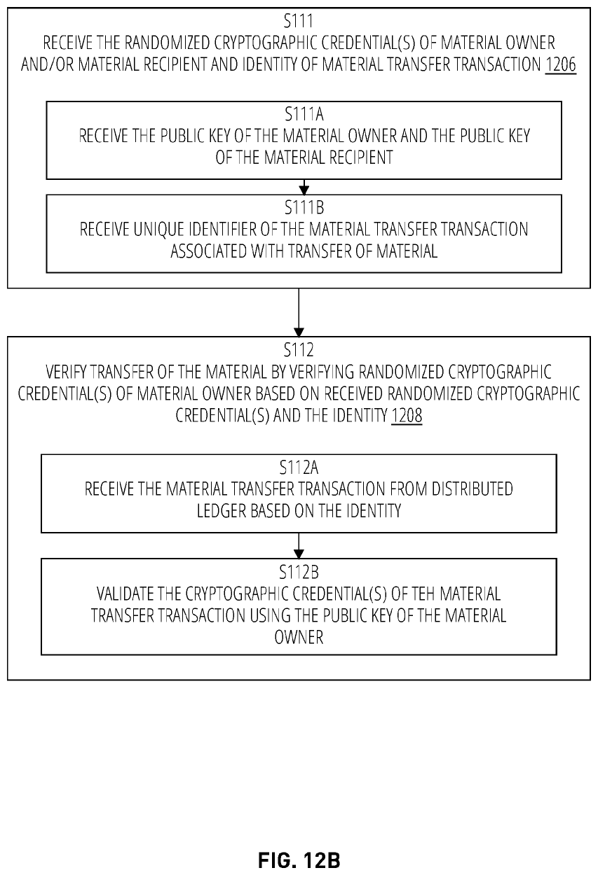

FIG. 12A is a flow chart illustrating the computer-implemented method of the present application.

In step S111, the randomized cryptographic credential(s) of material owner and/or material recipient and the identity of material transfer transaction are received, e.g., by a requesting party. The requesting party may be a recipient or a third party.

The credentials being randomized may entail that the respective public/private key pair is unique to one single transaction. As such, the level of data privacy is increased, particularly in terms of avoiding pattern analysis.

In step S112, the transfer of the material is verified by verifying the randomized cryptographic credential(s) of the material owner and/or material recipient based on the received randomized cryptographic credential(s) and the received identity of the material transfer transaction.

FIG. 12B is a flowchart illustrating a more detailed example for such a computer-implemented method. For example, step S111 may comprise step S111A of receiving the public key of the material owner and/or the public key of the material recipient. Step S111 may further comprise step S111B of receiving the unique identifier of the material transfer transaction associated with the transfer of the material.

Step S112 may comprise step S112A of retrieving the material transfer transaction from the distributed ledger based on the identity. Step S112 may further comprise step 112B of validating the cryptographic credential(s) contained in the material transfer transaction using the public key of the material owner and/or material recipient.

As an even more detailed example, when creating a transaction, randomized credentials that are unique and generated and used only for a single transaction may be generated for the material owner and/or material recipient. The material recipient may provide part of the randomized credentials, for example the public key, of the material recipient to the material owner.

Part of said credentials, e.g. a public key, may be written into the transaction and the material owner may, in addition, sign the transaction using the private key of the material owner.

The created transaction will be assigned a unique transaction ID provided to the material owner, who may then pass it on to the material recipient together with or separately from the public key of the material owner used for the transaction and optionally the public key of the recipient used for the transaction. The latter is not necessary, but may in some cases be advantageous for consistency checks.

If the transaction is signed by the material owner, the material recipient may verify the signature using the material owner's public key generated and used for the transaction.

After the transaction has been committed to and stored in the distributed ledger, a requesting party may wish to verify the transfer of the material. To that end, they may receive the credentials used for the transaction and the transaction ID. They may then retrieve the transaction from the distributed ledger using the transaction ID. The material transfer may then be verified using the received credentials.

An even more detailed example of a method of the present disclosure is provided below. Prior to creating a transaction for commitment to the distributed ledger, contractual partners may exchange public keys for establishing an asymmetrically encrypted communication channel, for example, upon establishing a supply contract. PGP encryption may be used, as an example.

Other methods of secure data exchange may, however, be used.

Each party may keep a key vault wherein asymmetric keys matched to a specific communication channel are stored, e.g., via communication channel IDs (sender plain ID, receiver plain ID, contract plain ID).

Prior to creating a transaction for commitment to the distributed ledger, a public/private key pair PubK-S/PrivK-S may be created by the material owner and sender of the transaction, wherein a key pair may be created that is unique for said transaction. The public key PubK-S may be transmitted to the material recipient. Moreover, a request may be sent to the recipient to provide, to the sender, a public key PubK-R that is unique for said transaction. PubK-S and the request may be transmitted via the encrypted communication channel.

In response to receiving the public key and/or the request, the recipient may create a new public/private key pair PubK-R/PrivK-R. The key pair is stored at the recipient together with the communication channel ID, e.g., sender plain ID. The recipient's public key PubK-R is provided to the sender, e.g., via the communication channel. The order may also be reversed in case the recipient initiates the transfer.

The sender may then create a transaction, optionally sign it with the sender's private key PrivK-S, and address the transaction to the recipient's public key PubK-R.

The sender stores, e.g. in a private data base, which may optionally also hold a private copy of the transaction and the private key PrivK-S used for signing the transaction, i.e., the sender transaction signature. The sender may store as part of or separate to a private copy of the transaction, the recipient's public key PubK-R, i.e., the recipient transaction address and the transaction ID, and optionally transaction metadata and/or a hash of metadata.

The sender may optionally send the sender's public key PubK-S, i.e., the sender transaction address, the recipient's private key PubK-R, i.e., the recipient transaction address, the transaction ID, transaction meta data, and/or a hash of meta data to the recipient, e.g., via the private communication channel. In particular, the sender may refrain from submitting the transaction meta data and may only provide information enabling the recipient to perform read-only access or look-up, e.g., in the sender's data base and for mapping to the transaction.

The recipient may verify a transaction, e.g., perform on-chain attestation. As an example, the recipient may look up the transaction ID and verify, with the sender's public key PubK-S that the transaction is signed with the sender's private key PrivK-S, i.e., that the private key is encoded in the transaction.

Optionally, a confidential verification may also be performed by a third party, e.g., a certified authority or regulator. The third party may initiate a key exchange with the sender to establish a private communication channel or may establish some other type of secure communication channel. The third party may then request, via the communication channel, the public keys of the sender for one or more transactions, e.g. based on one or more transaction IDs. The regulator may then verify, for each transaction, using the respective PubK-S of the transaction that the respective private key PrivK-S of the sender is encoded in the transaction, i.e., that the transaction is properly signed.

According to the present disclosure, material transactions may comprise different types of transactions. For example, a material transfer transaction may be a create transaction. A create transaction may be a type of transaction that represent the introduction of a, e.g., raw or virgin, material into a production process. By means of the method of the present disclosure, limitations may be implemented as to which participant is a material owner eligible for a create transaction. Thus, it is possible to closely control any points of entry into the production process.

For example, there may be whitelists or blacklists of parties eligible to have create transactions committed to the distributed ledger. It is noted that a create transaction will not have a preceding transaction within the chain of transactions. Accordingly, some checks, for example of mass balances or the like, that may be applied within the chain of transactions cannot be applied for a create transactions, which makes it all the more important to allow create transactions only for trustworthy parties.

Another type of transaction may be an in-process transfer transaction, which may be any transaction that does not introduce or dispose of material. These transactions will have preceding transactions. This may, for example, allow for performing mass balancing and ensuring that material does not simply appear or disappear.

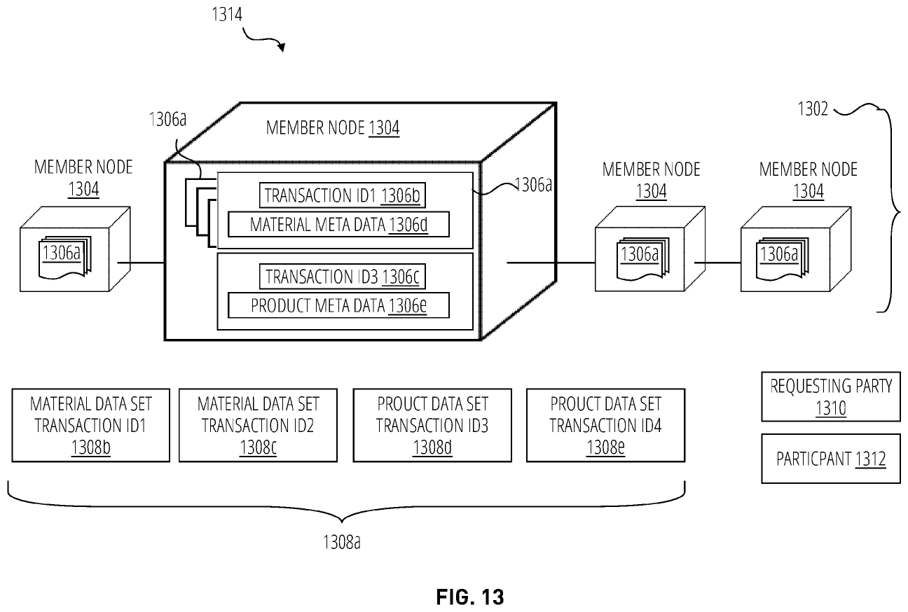

FIG. 13 shows a block diagram illustrating a decentral material network 1314 that may be used by the method of the present disclosure. The decentral material network comprises a distributed ledger 1302 that includes multiple member nodes 1304 and a distributed ledger application according to the present disclosure. Only one of the member nodes is shown in detail for the sake of simplicity. Each transaction contains a transaction ID 1306b, 1306c. In addition each transaction contains material data or material meta data 1306d of a material, in which case the transaction may be referred to as a material transaction, or contains product data or product meta data 1306e of a product, in which case the transaction may be referred to as a product transaction.

The member node may be in communication with a requesting party 1310, e.g., a requestor computer device, also referred to in short as requestor, e.g., via a data connection. The requesting party, e.g., requestor computer device, may also be in communicative communication, e.g., via another data connection, with a participant 1312, e.g., a participant computing device.

The requesting party may be configured to receive a material or product data set 1308a, for example one or more material data sets 1308b, 1308c, each comprising an identity e.g., transaction ID, of a transaction associated with a material. The requesting party may, alternatively or in addition, be configured to receive one or more product data sets 1308d, 1308e, each comprising an identity, e.g., a transaction ID, of a transfer transaction associated with a product. That is, the requesting party may receive, for a given material or product, a data set that contains at least an identity of an associated transfer transaction. The requesting party may, thus, find information stored in the associated transfer transaction using the identity contained in the material product data set.

The requesting party may further be configured to determine, based on the received material data set, an identity of a transfer transaction associated with a product associated with the material. This may be done for only one or each of a plurality of transfer transactions, each associated with a product associated with the material. In other words, the requesting party may be configured to identify transfer transactions associated with products associated with the material, e.g., products that contain the material. As such, the destination of the material can be determined. If the material is a re-used material, the origin thereof may similarly be determined by identifying associated products. The requesting party may, for example, retrieve the identity of the transaction associated with the material from the material data set and, based thereon, retrieve the identity or identities of transfer transactions associated with the product(s) associated with the material. To that end, as an example, a chain of transaction IDs may be determined to trace the transfers associated with the material and/or product(s).

The requesting party may further be configured to receive product property data of the product, which may be determined by determining a transfer chain participant associated with the product and receiving from said participant the product property data. Optionally, the requesting party may provide a product property to the participant. The product property data received from the participant may be retrieved based on the determined identity of the transfer transaction associated with product and optionally based on the product property provided to the participant. The product property may aid in retrieving relevant data more efficiently, e.g., by providing a pre-selection among available material property data.

In order to receive the product property data from the participant, the requesting party may transmit, to the participant, a request containing the determined identity of the transfer transaction associated with the product, cryptographic credentials of a material owner of the material, and optionally the product property. After validation of the cryptographic credentials by the participant, the participant may provide the product property data to the requesting party in case the credentials are valid. Otherwise, the participant may reject the request.

In the manner outlined above, the requesting party may thus determine a flow of the material in a transfer chain using the decentral material network 1314. Specifically, the requesting party may thus determine an origin or destination of the material.

Alternatively or in addition, the requesting party may be configured to determine, based on the received product data set, an identity of a transfer transaction associated with a material associated with the product, e.g., comprised in the product or obtained from a product for re-use. This may be done for only one or each of a plurality of transfer transactions, each associated with a material associated with the product. In other words, the requesting party may be configured to identify transfer transactions associated with materials associated with the product. As such, any materials having gone into a product or resulting from recycling of the product may be determined. The requesting party may, for example, retrieve the identity of the transaction associated with the product from the product data set and, based thereon, retrieve the identity or identities of transfer transactions associated with the material(s) associated with the product. To that end, as an example, a chain of transaction IDs may be determined to trace the transfers associated with the material(s).

The requesting party may further be configured to receive material property data of the material, which may be determined by determining a transfer chain participant associated with the material and receiving from said participant the material property data. Optionally, the requesting party may provide a material property to the participant. The material property data received from the participant may be retrieved based on the determined identity of the transfer transaction associated with material and optionally based on the material property provided to the participant. The material property may aid in retrieving relevant data more efficiently, e.g., by providing a pre-selection among available material property data.

In order to receive the material property data from the participant, the requesting party may transmit, to the participant, a request containing the determined identity of the transfer transaction associated with the material, cryptographic credentials of a product owner of the product, and optionally the material property. After validation of the cryptographic credentials by the participant, the participant may provide the material property data to the requesting party in case the credentials are valid. Otherwise, the participant may reject the request.

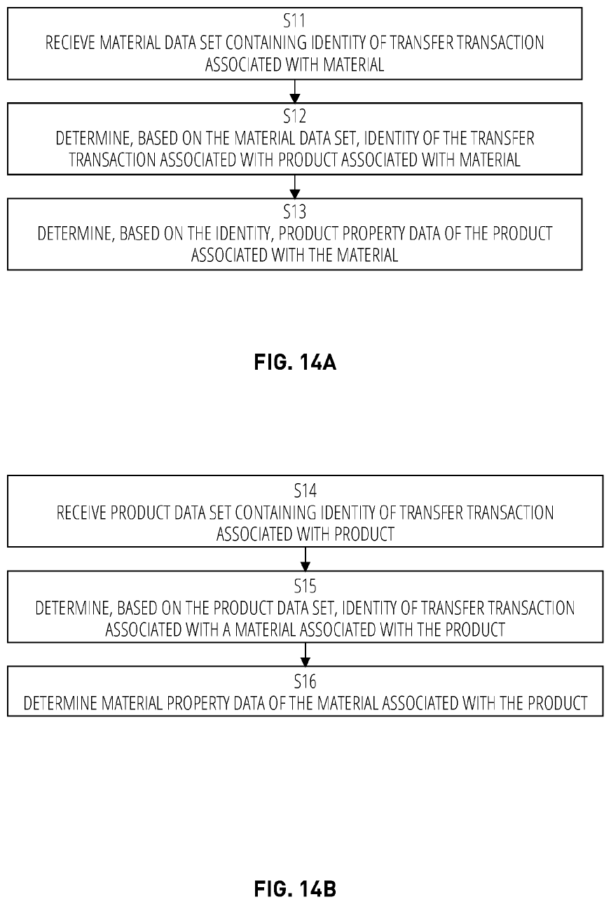

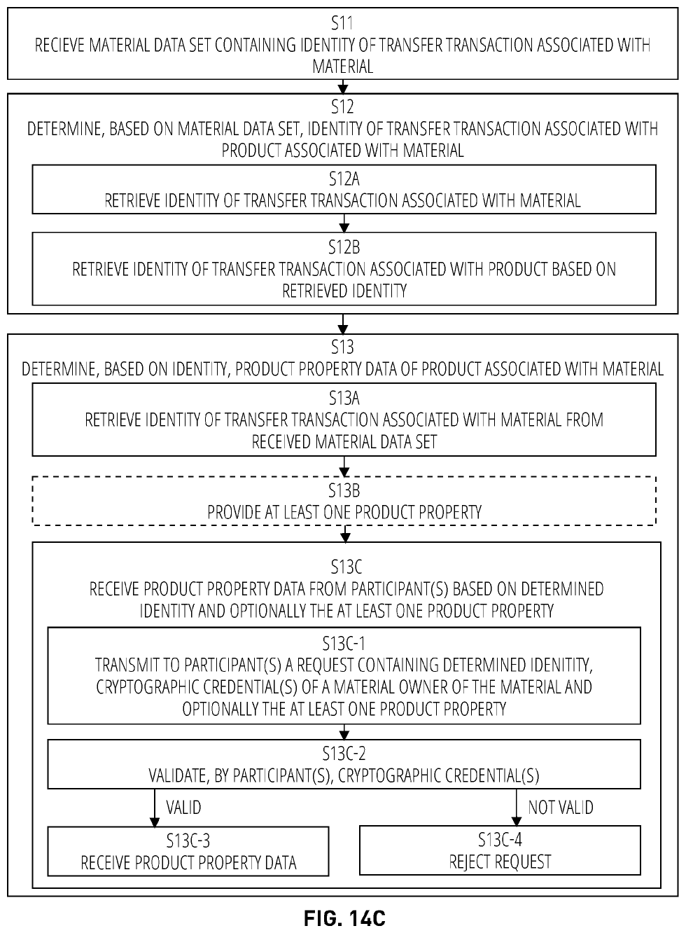

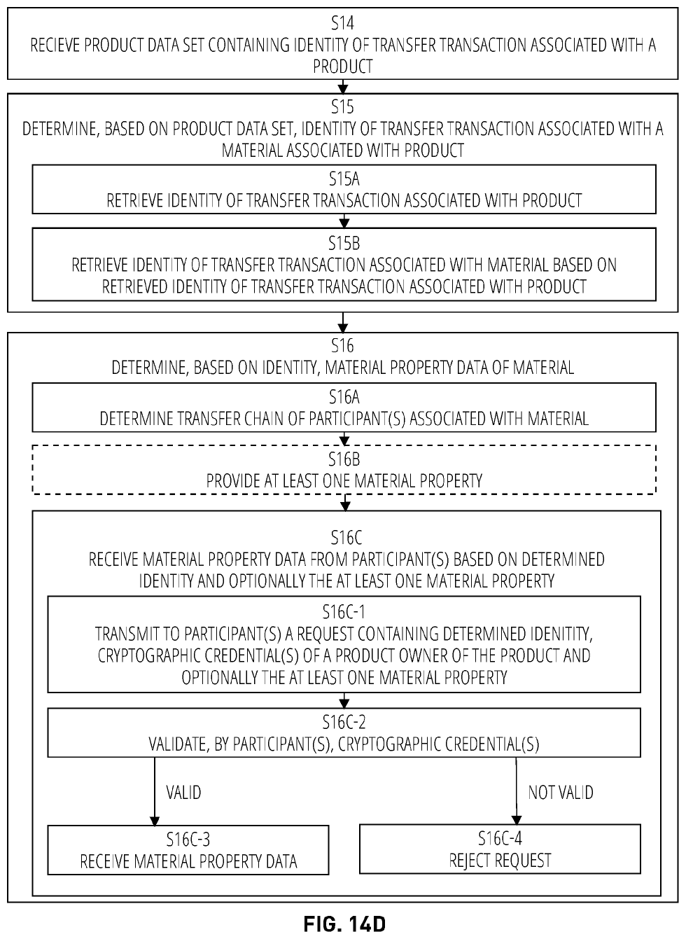

In the manner outlined above, the requesting party may thus determine a flow of the material in a transfer chain using the decentral material network 1314. Specifically, the requesting party may thus determine, for a given products, which materials flowed into and out of the product. FIGS. 14A to 14D are flow chart illustrating the computer-implemented method of the present disclosure.

FIG. 14A illustrates a method wherein, for a given material, product property data of a product associated with the material are determined. This is illustrated for one product, but may be performed for multiple products associated with the material, particularly all products associated with the material.

According to the present disclosure, a method for determining the flow of a material in a transfer chain using a decentral material network 1314 comprising a distributed ledger 1302 that includes multiple member nodes 1304, the distributed ledger 1302 including transfer transactions 1306a is provided. Each of the transfer transactions 1306a is associated with a material and contains material data of the material or is associated with a product and contains product data of the product.

In step S11, a material data set containing an identity of a transfer transaction associated with a material is received, e.g., at a requesting party.

In step S12, based on the received material data set, an identity of a transfer transaction associated with a product associated with the material is determined, e.g., by the requesting party.

In step S13, product property data of the product is determined based on the identity of the transfer transaction associated with the product. This may be carried out at least in part by a requesting party. Optionally, a transfer chain participant may also carry out part of this step.

FIG. 14B illustrates a method wherein, for a given product, material property data of a material associated with the product are determined. This is illustrated for one material, but may be performed for multiple materials associated with the product, particularly all materials associated with the product.

According to the present disclosure, a method for determining the flow of a material in a transfer chain using a decentral material network 1314 comprising a distributed ledger 1302 that includes multiple member nodes 1304, the distributed ledger 1302 including transfer transactions 1306a is provided. Each of the transfer transactions 1306a is associated with a material and contains material data of the material or is associated with a product and contains product data of the product.

In step S14, a product data set containing an identity of a transfer transaction associated with a product is received, e.g., at a requesting party.

In step S15, based on the received product data set, an identity of a transfer transaction associated with a material associated with the product is determined, e.g., by the requesting party.

In step S16, material property data of the material is determined based on the identity of the transfer transaction associated with the material. This may be carried out at least in part by a requesting party. Optionally, a transfer chain participant may also carry out part of this step.

The methods of FIGS. 14A and 14B may also be combined. For example, product property data of a product associated with a given material may be determined and material property data of (other) material(s) associated with the product may also be determined.

FIG. 14C illustrates a method according to the present disclosure that comprises the steps as outlined in the context of FIG. 14C. Accordingly, reference is made to the description above, particularly in terms of steps S11 to S13, as such. Steps S12 and S13 are shown in more detail in FIG. 14C and optional steps are also shown therein. S12 may comprise steps S12A and S12B. Alternatively or in addition, step S13 may comprise step S13A, optionally step S13B, and step S13C. As a specific optional example, step S13C may comprise steps S13C-1, S13C-2, S13C-3, and/or S13C-4.

In step S12A, the identity of the transfer transaction associated with the material is retrieved from the received material data set, e.g., by the requesting party.

In step S12B, the identity of the transfer transaction associated with the product associated with the material is retrieved based on the retrieved identity of the transfer transaction associated with the material, e.g., by the requesting party.

In step S13A, transfer chain participant(s) associated with the product are determined, e.g., by the requesting party.

In optional step S13B, a product property of the product is provided to the participant(s), e.g., by the requesting party.

In optional step S13C, product property data is received from the participant(s) based on the determined identity of the transfer transaction associated with the product and optionally based on the provided product property.

More specifically, in step S13C-1, a request containing the determined identity of the transfer transaction associated with the product, cryptographic credentials of a material owner of the material, and optionally the product property of the product is transmitted to the transfer chain participant(s).

In step S13C-2, the transfer chain participant validates the credentials.

In step S13C-3, if the credentials are valid, the product property data are provided, e.g., by the participant, based on the determined identity of the transfer transaction associated with the product and optionally based on the product property.

In step S13C-4, if the credential(s) are invalid, the request is rejected, e.g., by the participant. In particular, the material owner may be the requestor.

In the above method, rather than performing the respective steps, the requesting party and/or participant may cause other parties, e.g., a service provider, to perform some or all of the respective steps in their stead.

FIG. 14D illustrates a method according to the present disclosure that comprises the steps as outlined in the context of FIG. 14B. Accordingly, reference is made to the description above, particularly in terms of steps S14 to S16, as such. Steps S15 and S16 are shown in more detail in FIG. 14D and optional steps are also shown therein. S15 may comprise steps S15a and S15b. Alternatively or in addition, step S16 may comprise step S16A, optionally step S16B, and step S16C. As a specific optional example, step S16C may comprise steps S16C-1, S16C-2, S16C-3, and/or S16C-4.

In step S15A, the identity of the transfer transaction associated with the product is retrieved from the received product data set, e.g., by the requesting party.

In step S15B, the identity of the transfer transaction associated with the material associated with the product is retrieved based on the retrieved identity of the transfer transaction associated with the product e.g., by the requesting party.

In step S16A, transfer chain participant(s) associated with the material are determined, e.g., by the requesting party.

In optional step S16B, a material property of the material is provided to the participant(s), e.g., by the requesting party.

In optional step S16C, material property data is received, e.g. from the participant(s), based on the determined identity of the transfer transaction associated with the material and optionally based on the provided material property.

More specifically, in step S16C-1, a request containing the determined identity of the transfer transaction associated with the material, cryptographic credentials of a product owner of the product, and optionally the material property of the material is transmitted to the transfer chain participant(s).

In step S16C-2, the transfer chain participant validates the credentials.

In step S16C-3, if the credentials are valid, the material property data are received by the requesting party, e.g., provided by the participant, based on the determined identity of the transfer transaction associated with the material and optionally based on the material property. In step S16C-4, if the credential(s) are invalid, the request is rejected, e.g., by the participant. In particular, the product owner may be the requestor.

In the above method, rather than performing the respective steps, the requesting party and/or participant may cause other parties, e.g., service providers, to perform some or all of the respective steps in their stead.

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at different nodes using different equipment/data processing.

1. A computer-implemented method for verifying a transfer of a material between a material owner and a material recipient in a decentral network comprising a distributed ledger that includes comprises multiple member nodes and a distributed ledger application, the method including the steps of:
transmitting, by a requestor, a material transaction request to the distributed ledger application, the material transaction request comprising material data associated with the material, and cryptographic credential(s) of the material owner and optionally the cryptographic credential(s) of the material recipient associated with the transfer of the material; and
receiving confirmation, or denial of a commitment of the material transaction request as material transaction to the distributed ledger, wherein the distributed ledger application is configured to:
receive the material transaction request from the requestor,
verify the transfer of the material associated with the material transaction request (314) by validating the cryptographic credential(s) of the material owner and optionally the cryptographic credential(s) of the material recipient contained in the material transaction request,
commit—if the transfer of the material is verified—the material transaction request as material transaction to the distributed ledger and transmit the confirmation of commitment of the material transaction request, or
transmit—if the transfer of the material is not verified—the denial of commitment of the material transaction request.

2. The method of claim 1, wherein the material is a discrete or indiscrete material and/or wherein the material is a chemical raw material, and/or wherein the material is transferred in a linear production process or in a circular process.

3. The method according to claim 1, wherein the material data comprises transaction meta data and optionally the amount of the material transferred from the material owner to the material recipient, optionally, wherein transaction meta data includes a material identifier, at least one material classification, material production data or a combination thereof, the material identifier optionally including a digital representation pointing to a material data set or parts thereof.

4. The method of claim 3,
wherein the material data set is received from a data providing service and/or
wherein the material data set comprises a decentral identifier and data related to the material, optionally, wherein the material data set further comprises data related to one or more authentication mechanisms associated with the decentral identifier or is related to one or more authorization mechanisms associated with the decentral identifier.

5. The method of claim 4, wherein the data related to the material comprises one or more digital representation(s) pointing to a/the material data set or parts thereof, in optionally, wherein the material data set comprises the material name, the material ID, the material composition, chemical and/or physical properties of the material, emission data of the material, recyclate content of the material, bio-based content of the material, further material production data, material declaration data, chemical material safety data, certificate of analysis data associated with the material, or a combination thereof.

6. The method according to claim 1, wherein the cryptographic credential(s) of the material owner comprise(s) the public key, and optionally the private key and/or the cryptographic signature of the material owner, and/or
wherein the cryptographic credential(s) of the material recipient comprise(s) the public key, and optionally the private key and/or the cryptographic signature of the material recipient.

7. The method according to claim 1, wherein the confirmation or the denial of commitment of the material transaction request is received by the requestor.

8. The method according to claim 1, wherein validating the cryptographic credential(s) of the material owner comprises retrieving a list containing cryptographic credential(s) and comparing the cryptographic credential(s) of the material owner with the cryptographic credential(s) contained in the retrieved list, optionally, wherein the transfer of the material is verified if the cryptographic credential(s) contained in the material transaction request is/are not matching the cryptographic credential(s) contained in the retrieved list.

9. The method according to claim 1, wherein the distributed ledger comprises material transactions, each material transaction being associated with a transfer of a material from a material owner to a material recipient, said material transactions including a transaction identity and material data associated with the material.

10. The method of claim 9, wherein validating the cryptographic credential(s) of the material owner includes retrieving a list containing transaction identities of material transactions and comparing the transaction identity associated with the material transaction request with the transaction identities contained in the retrieved list, optionally, wherein the transfer of the material is verified if the transaction identity associated with the received material transaction request is not matching a transaction identity contained in the retrieved list.

11. The method according to claim 1, wherein validating the cryptographic credential(s) of the material owner and the cryptographic credential(s) of the material recipient includes validating the cryptographic signature of the material owner and the material recipient.

12. The method of claim 1, wherein the distributed ledger application is stored on each member node of the distributed ledger, and/or wherein the distributed ledger application is a smart contract.

13. An apparatus for verifying a transfer of a material between a material owner and a material recipient in a decentral material network comprising a distributed ledger that includes multiple member nodes and a distributed ledger application, the apparatus comprising:
one or more computing nodes (101, 101.1, . . . ,101.n); and one or more computer-readable media having stored thereon computer-executable instructions that are structured such that, when executed by the one or more computing nodes, they cause the apparatus to perform the following steps:
transmitting, by a requestor, a material transaction request to the distributed ledger application, the material transaction request comprising material data associated with the material, and cryptographic credential(s) of the material owner and optionally the cryptographic credential(s) of the material recipient associated with the transfer of the material; and
receiving confirmation, or denial of a commitment of the material transaction request as material transaction to the distributed ledger, wherein the distributed ledger application is configured to:
receive the material transaction request from the requestor,
verify the transfer of the material associated with the material transaction request by validating the cryptographic credential(s) of the material owner and optionally the cryptographic credential(s) of the material recipient contained in the material transaction request,
commit—if the transfer of the material is verified—the material transaction request as material transaction to the distributed ledger and transmit the confirmation of commitment of the material transaction request, or
transmit—if the transfer of the material is not verified—the denial of commitment of the material transaction request.

14. A method for controlling the introduction of material into a production process comprising using a material transfer verified according to the method of claim 1.

15. A computer element with instructions, which, when the instructions are executed on one or more computing node(s), cause an apparatus to carry out the steps of the method of claim 1.

16. A computer clement with instructions which are configured to be carried out by the apparatus of claim 13.
